(19) United States
(12) Patent Application Publication
(10) Pub. No.: US 2022/0374334 A1
(43) Pub. Date: Nov. 24, 2022

(54) TECHNIQUES FOR VISUAL SOFTWARE TEST AUTOMATION MANAGEMENT

(71) Applicant: Infor (US), LLC, New York, NY (US)

(72) Inventors: Jeffrey Allen Brown, Colorado Springs, CO (US); Tharaka Deshan Hewa Walpita, Pannipitiya (LK)

(21) Appl. No.: 17/328,877

(22) Filed: May 24, 2021

(51) Int. Cl. G06F 11/36

(52) U.S. Cl. CPC G06F 11/3664; G06F 11/3688

(57) ABSTRACT

Various embodiments of the present invention provide methods, apparatuses, systems, computing devices, computing entities, and/or the like for executing efficient and techniques for generating automated testing workflow data entities based at least in part on session data entities, integrating nestable automated testing workflow data entities based at least in part on session data entities into integrative automated testing workflow data entities based at least in part on session data entities, and generating execution longs for automated testing workflow data entities based at least in part on session data entities.

### BACKGROUND

Various embodiments of the present invention address technical challenges related to software testing and make substantial technical improvements to improving the computational efficiency and operational reliability of test automation platforms, as well as to the operational reliability of software applications that are tested using the software application platforms.

### BRIEF SUMMARY

In general, embodiments of the present invention provide methods, apparatuses, systems, computing devices, computing entities, and/or the like for executing efficient and techniques for generating automated testing workflow data entities based at least in part on session data entities, integrating nestable automated testing workflow data entities based at least in part on session data entities into integrative automated testing workflow data entities based at least in part on session data entities, and generating execution longs for automated testing workflow data entities based at least in part on session data entities.

In accordance with one aspect, a method is provided. In one embodiment, the method comprises: generating a session data entity during one or more sessions of an end user, wherein: the session data entity comprises (a) an ordered sequence of a plurality of captured page images that (i) were captured during the one or more sessions, and (ii) correspond to a plurality of webpages visited by the end user during the one or more sessions, and (b) a plurality of captured user interactions executed by the end user interacting with the plurality of webpages, each captured user interaction is associated with a captured page image of the plurality of captured page images, each captured page image comprises one or more interactive page elements, and each captured user interaction corresponds to an interactive page element of the plurality of interactive user elements in the captured page image; generating the automated testing workflow data entity based at least in part on the session data entity, wherein: the automated testing workflow data entity comprises (a) a plurality of the plurality of captured page images, and (b) one or more automated testing workflow steps associated with each of the plurality of captured page images, each automated testing workflow step is associated with a captured user interaction of the plurality of captured user interactions, generating each automated testing workflow step is executed based at least in part on one or more action features of the captured user interaction that corresponds to the automated testing workflow step, each automated testing workflow step is mapped to the interactive page element of the captured user interaction that is associated with the automated testing workflow data entity, and the automated testing workflow data entity is configured to add a new automated testing workflow step to the one or more automated testing workflow steps for a captured page image by interaction of the end user with the one or more interactive page elements in the captured page image; and providing access to the automated testing workflow data entity, wherein the automated testing workflow data entity is configured to enable executing one or more automated software testing operations.

In accordance with another aspect, a computer program product is provided. The computer program product may comprise at least one computer-readable storage medium having computer-readable program code portions stored therein, the computer-readable program code portions comprising executable portions configured to: generate a session data entity during one or more sessions of an end user, wherein: the session data entity comprises (a) an ordered sequence of a plurality of captured page images that (i) were captured during the one or more sessions, and (ii) correspond to a plurality of webpages visited by the end user during the one or more sessions, and (b) a plurality of captured user interactions executed by the end user interacting with the plurality of webpages, each captured user interaction is associated with a captured page image of the plurality of captured page images, each captured page image comprises one or more interactive page elements, and each captured user interaction corresponds to an interactive page element of the plurality of interactive user elements in the captured page image; generate the automated testing workflow data entity based at least in part on the session data entity, wherein: the automated testing workflow data entity comprises (a) a plurality of the plurality of captured page images, and (b) one or more automated testing workflow steps associated with each of the plurality of captured page images, each automated testing workflow step is associated with a captured user interaction of the plurality of captured user interactions, generating each automated testing workflow step is executed based at least in part on one or more action features of the captured user interaction that corresponds to the automated testing workflow step, each automated testing workflow step is mapped to the interactive page element of the captured user interaction that is associated with the automated testing workflow data entity, and the automated testing workflow data entity is configured to add a new automated testing workflow step to the one or more automated testing workflow steps for a captured page image by interaction of the end user with the one or more interactive page elements in the captured page image; and provide access to the automated testing workflow data entity, wherein the automated testing workflow data entity is configured to enable executing one or more automated software testing operations.

In accordance with yet another aspect, an apparatus comprising at least one processor and at least one memory including computer program code is provided. In one embodiment, the at least one memory and the computer program code may be configured to, with the processor, cause the apparatus to: generate a session data entity during one or more sessions of an end user, wherein: the session data entity comprises (a) an ordered sequence of a plurality of captured page images that (i) were captured during the one or more sessions, and (ii) correspond to a plurality of webpages visited by the end user during the one or more sessions, and (b) a plurality of captured user interactions executed by the end user interacting with the plurality of webpages, each captured user interaction is associated with a captured page image of the plurality of captured page images, each captured page image comprises one or more interactive page elements, and each captured user interaction corresponds to an interactive page element of the plurality of interactive user elements in the captured page image; generate the automated testing workflow data entity based at least in part on the session data entity, wherein: the automated testing workflow data entity comprises (a) a plurality of the plurality of captured page images, and (b) one or more automated testing workflow steps associated with each of the plurality of captured page images, each automated testing workflow step is associated with a captured user interaction of the plurality of captured user interactions, generating each automated testing workflow step is executed based at least in part on one or more action features of the captured user interaction that corresponds to the automated testing workflow step, each automated testing workflow step is mapped to the interactive page element of the captured user interaction that is associated with the automated testing workflow data entity, and the automated testing workflow data entity is configured to add a new automated testing workflow step to the one or more automated testing workflow steps for a captured page image by interaction of the end user with the one or more interactive page elements in the captured page image; and provide access to the automated testing workflow data entity, wherein the automated testing workflow data entity is configured to enable executing one or more automated software testing operations.

In accordance with one aspect, a method is provided. In one embodiment, the method comprises: detecting one or more nestable workflow modifications for the nestable automated testing workflow data entity, wherein the nestable automated testing workflow data entity is associated with a plurality of nestable captured page images and a plurality of nestable automated testing workflow steps; identifying one or more integrative automated testing workflow data entities that have integrated the nestable automated testing workflow data entity; for each integrative automated testing workflow data entity: determining a target image subset of a plurality of captured page images of the integrative automated testing workflow data entity that correspond to the plurality of nestable captured page images, determining a target step subset of a plurality of automated testing workflow steps of the integrative automated testing workflow data entity that correspond to the plurality of nestable automated testing workflow steps, and updating each captured page image in the target image subset and each automated testing workflow step in the target step subset based at least in part on the one or more nestable workflow modifications; and providing access to the one or more integrative automated testing workflow data entities, wherein the one or more integrative automated testing workflow data entities are configured to enable executing one or more automated software testing operations.

In accordance with another aspect, a computer program product is provided. The computer program product may comprise at least one computer-readable storage medium having computer-readable program code portions stored therein, the computer-readable program code portions comprising executable portions configured to: detect one or more nestable workflow modifications for the nestable automated testing workflow data entity, wherein the nestable automated testing workflow data entity is associated with a plurality of nestable captured page images and a plurality of nestable automated testing workflow steps; identify one or more integrative automated testing workflow data entities that have integrated the nestable automated testing workflow data entity; for each integrative automated testing workflow data entity: determine a target image subset of a plurality of captured page images of the integrative automated testing workflow data entity that correspond to the plurality of nestable captured page images, determine a target step subset of a plurality of automated testing workflow steps of the integrative automated testing workflow data entity that correspond to the plurality of nestable automated testing workflow steps, and update each captured page image in the target image subset and each automated testing workflow step in the target step subset based at least in part on the one or more nestable workflow modifications; and provide access to the one or more integrative automated testing workflow data entities, wherein the one or more integrative automated testing workflow data entities are configured to enable executing one or more automated software testing operations.

In accordance with yet another aspect, an apparatus comprising at least one processor and at least one memory including computer program code is provided. In one embodiment, the at least one memory and the computer program code may be configured to, with the processor, cause the apparatus to: detect one or more nestable workflow modifications for the nestable automated testing workflow data entity, wherein the nestable automated testing workflow data entity is associated with a plurality of nestable captured page images and a plurality of nestable automated testing workflow steps; identify one or more integrative automated testing workflow data entities that have integrated the nestable automated testing workflow data entity; for each integrative automated testing workflow data entity: determine a target image subset of a plurality of captured page images of the integrative automated testing workflow data entity that correspond to the plurality of nestable captured page images, determine a target step subset of a plurality of automated testing workflow steps of the integrative automated testing workflow data entity that correspond to the plurality of nestable automated testing workflow steps, and update each captured page image in the target image subset and each automated testing workflow step in the target step subset based at least in part on the one or more nestable workflow modifications; and provide access to the one or more integrative automated testing workflow data entities, wherein the one or more integrative automated testing workflow data entities are configured to enable executing one or more automated software testing operations.

In accordance with one aspect, a method is provided. In one embodiment, the method comprises: identifying an ordered sequence of automated testing workflow steps for the automated testing workflow data entity; causing a computing entity to execute a required number of workflow playback operations based at least in part on the ordered sequence, wherein: each workflow playback operation is associated with an automated testing workflow step in the ordered sequence, the required number of workflow playback operations stop with a terminal workflow playback operation that is associated with a target automated testing workflow step that is a first automated testing workflow step with a negative success indicator, and executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step; generating the execution log based at least in part on the modified web environment state for the target automated testing workflow step; and providing access to the execution log using a workflow visualization playback user interface, wherein the workflow playback visualization user interface is configured to: (i) display the execution log; and (ii) enable modifying the target automated testing workflow step.

In accordance with another aspect, a computer program product is provided. The computer program product may comprise at least one computer-readable storage medium having computer-readable program code portions stored therein, the computer-readable program code portions comprising executable portions configured to: identify an ordered sequence of automated testing workflow steps for the automated testing workflow data entity; cause a computing entity to execute a required number of workflow playback operations based at least in part on the ordered sequence, wherein: each workflow playback operation is associated with an automated testing workflow step in the ordered sequence, the required number of workflow playback operations stop with a terminal workflow playback operation that is associated with a target automated testing workflow step that is a first automated testing workflow step with a negative success indicator, and executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step; generate the execution log based at least in part on the modified web environment state for the target automated testing workflow step; and provide access to the execution log using a workflow visualization playback user interface, wherein the workflow playback visualization user interface is configured to: (i) display the execution log; and (ii) enable modifying the target automated testing workflow step.

In accordance with yet another aspect, an apparatus comprising at least one processor and at least one memory including computer program code is provided. In one embodiment, the at least one memory and the computer program code may be configured to, with the processor, cause the apparatus to: identify an ordered sequence of automated testing workflow steps for the automated testing workflow data entity; cause a computing entity to execute a required number of workflow playback operations based at least in part on the ordered sequence, wherein: each workflow playback operation is associated with an automated testing workflow step in the ordered sequence, the required number of workflow playback operations stop with a terminal workflow playback operation that is associated with a target automated testing workflow step that is a first automated testing workflow step with a negative success indicator, and executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step; generate the execution log based at least in part on the modified web environment state for the target automated testing workflow step; and provide access to the execution log using a workflow visualization playback user interface, wherein the workflow playback visualization user interface is configured to: (i) display the execution log; and (ii) enable modifying the target automated testing workflow step.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2A provides an example web server computing entity in accordance with some embodiments discussed herein;

FIG. 2B provides an example client computing entity in accordance with some embodiments discussed herein;

FIG. 3 provides an exemplary diagram of an automated testing module that can be used to practice embodiments discussed herein;

FIGS. 4A-4D provide operational examples of various automated testing workflow visualization user interface in accordance with some embodiments discussed herein;

FIG. 5 is a flowchart diagram of an example process for generating an automated testing workflow data entity based at least in part on a session data entity in accordance with some embodiments discussed herein;

FIGS. 6A-6B provide an operational example of initiating a captured session in accordance with some embodiments discussed herein;

FIG. 7 provides an operational example of defining a short description of an automated testing workflow data entity and a Uniform Resource Locator (URL) of the starting webpage for the automated testing workflow data entity in accordance with some embodiments discussed herein;

FIGS. 8A-8C depict an operational example of a captured session in accordance with some embodiments discussed herein;

FIGS. 9A-9D provide operational examples of interacting with the workflow step action feature elements for a set of automated testing workflow steps in accordance with some embodiments discussed herein;

FIG. 10 is a flowchart diagram of an example process for modifying a nestable automated testing workflow data entity in accordance with some embodiments discussed herein;

FIG. 11 is a flowchart diagram of an example process for integrating two nestable automated testing workflow data entities into a destination automated testing workflow data entity in accordance with some embodiments discussed herein;

FIGS. 12A-12D provide operational examples of mapping an output parameter of a first nestable automated testing workflow data entity to an input parameter of a second nestable automated testing workflow data entity within destination automated testing workflow data entity in accordance with some embodiments discussed herein;

FIG. 13 is a flowchart diagram of an example process for generating an execution log for an automated testing workflow data entity in accordance with some embodiments discussed herein;

FIGS. 14A-14B provide operational examples of initiating a set of workflow playback operations in accordance with some embodiments discussed herein;

FIG. 15 is a flowchart diagram of executing a workflow playback operation in accordance with some embodiments discussed herein;

FIG. 16 is a flowchart diagram of generating a modified web environment state for a workflow playback operation in accordance with some embodiments discussed herein;

FIGS. 17A-17B provide operational examples of generating an operational log for a set of workflow playback operations in accordance with some embodiments discussed herein;

FIG. 18 provides an operational example of the workflow step action feature element for an automated testing workflow step having a negative success indicator in accordance with some embodiments discussed herein;

FIG. 19 is a flowchart diagram of an example process for generating a session data entity in accordance with some embodiments discussed herein;

FIG. 20 is a flowchart diagram of an example process for updating an integrative automated testing workflow data entity based at least in part on nestable workflow modifications in accordance with some embodiments discussed herein;

FIG. 21 provides an operational example of an automated testing workflow visualization user interface that is used to define an automated testing workflow step for a file upload user action in accordance with some embodiments discussed herein; and

FIG. 22 provides an operational example of an automated testing workflow visualization user interface that is used to define an automated testing workflow step for a file assertion user action in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to execute other types of data analysis.

### Overview and Technical Advantages

Provided below are techniques for generating automated testing workflow data entities based at least in part on session data entities, generating automated testing workflow data entities based at least in part on nestable automated testing workflow data entities, and generating execution logs for automated testing workflow data entities that can be used to modify the automated testing workflow data entities. Each of the noted techniques is configured to provide automated testing workflow generation techniques that are more user-friendly and intuitive. The user-friendly and intuitive automated testing workflow generation techniques enhance the accuracy and reliability of automated testing workflow data entities generated by software testing engineers, which in turn reduces the number of erroneous testing operations (e.g., erroneous automated testing operations) that are executed based at least in part on the noted automated testing workflow data entities.

Reducing the number of erroneous testing operations improves the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to enable software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

Moreover, embodiments of the present invention address technical challenges associated with efficiently and effectively generating and visualizing software testing operations. Various existing software testing solutions are not user-friendly and require high technical software knowledge and intimate familiarity with the software being tested. Furthermore, various existing software testing solutions do not operate in visually intuitive forms. To address the noted efficiency and effectiveness challenges associated with various existing software testing solutions, various embodiments of the present disclosure describe software testing operations related to generating and/or modifying automated testing workflow data entities in a visual and user-friendly manner. Various embodiments of the present disclosure also utilize a multi-tenant cloud architecture allowing multiple clients to utilize the embodiments of the present disclosure and to share software testing operations between themselves, such as part of a Software-as-a-Service (SaaS) architecture. In doing so, various embodiments of the present invention address technical challenge associated with efficiency and reliability of various software testing solutions. In some embodiments, the multi-tenant cloud architecture enables sharing platform costs across multiple clients, thereby reducing costs of a test automation platform, which, in conventional test automation platforms, are very expensive. By allowing customers to share the burden of costs, various embodiments of the present invention reduces the overall cost for the parties who interact/utilize a test automation platform.

### Definitions of Certain Terms

The term “automated testing workflow data entity” may refer to an electronically-stored data construct that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages (e.g., a sequence of webpages from multiple websites across multiple tabs with one or more sessions) associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

The term “test case data entity” may refer to an electronically-stored data construct that is configured to describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more captured page images associated with the test case; and (ii) for each captured page image of the one or more captured page images, a set of automated testing workflow steps that relate to the captured page image. In some embodiments, the test case data entity contains data that can be used to generate an automated testing workflow visualization user interface for the test case associated with the test case data entity, such as an automated testing workflow visualization user interface that depicts: (i) one or more captured page images associated with the test case; and (ii) for each captured page image of the one or more captured page images, a set of test case visualizations corresponding to each automated testing workflow step in the set of automated testing workflow steps that relate to the particular captured page image. In some embodiments, a test case may be described as one of a test case, a test plan, a use case, a test scenario, a test condition, a test script, a test suit, a set of test criteria, a set of test acceptance criteria, a user story, a set of software documentation data, a set of testing documentation data, and/or the like.

The term “captured page image” may refer to an electronically-stored data construct that is configured to describe an image associated with a state of a webpage that is visited during a test. For example, in some embodiments, a captured page image may depict a webpage image that is determined based at least in part on one or more session data entities associated with an automated testing workflow data entity. As another example, in some embodiments, a captured page image may depict a user-uploaded image and/or user-selected image that is configured to depict a state of a webpage associated with a corresponding automated testing workflow data entity. In some embodiments, each visited webpage associated with an automated testing workflow data entity may be associated with more than one captured page image, where each captured page image may depict a different state of the visited webpage. For example, consider a webpage that includes a dropdown menu interactive page element. In the noted example, some captured page images associated with the webpage may depict a visual state of the webpage in which the dropdown menu interactive page element is in a non-expanded state, while other captured page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some captured page images associated with the webpage may depict a visual state of the webpage in which the transitory notifications are displayed, while other captured page images associated with the webpage may depict a visual state of the webpage in which the transitory notifications are not displayed. In some embodiments, screen captures corresponding to captured page images are stored by reference within a relational database, so if a user updates or replaces a captured page image used in one test case data entity, say the test case data entity that corresponds to a login page, that updated captured page image will be reflected across all other test case data entities that use that same captured page image. This leads to a significant productivity gain as, without this feature, the user would have to locate, edit, and update each test case data entity that also uses this same captured page.

The term “automated testing workflow step” may refer to an electronically-stored data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; and (iii) a user action sequence identifier of the user action that may describe a temporal order of the user action within a set of sequential user actions executed with respect to interactive page elements of a webpage associated with the user action.

The term “webpage” may refer to a collection of data provided by a website and displayed to an end user via a web browser application. As described herein, a set of webpages may include different webpages displayed sequentially within a single web browser application tab and/or different webpages displayed across two or more web browser application tabs. As used herein, a website may comprise one or more webpages; thus, a plurality of webpages may be associated with one or more websites.

The term “session data entity” may refer to an electronically-stored data construct that is configured to describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and dragging an icon on the second webpage from a first location to a second location. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured; and (ii) for each webpage of the sequence of webpages, a set of user interactions executed in relation to the noted webpage. For example, for the exemplary session data entity described above, the session data entity may describe: (i) a sequence of webpages that describes that the first webpage was visited first and the second webpage was subsequently visited; (ii) for the first webpage, the user interactions corresponding to entering a text input in the first designated textbox on the first webpage, selecting the first designated checkbox on the first webpage, and selecting the first designated button on the first webpage; and (iii) for the second webpage, the user interactions corresponding to selecting the first designated radio button from the first designated set of related radio buttons on the second webpage and dragging and dropping the icon on the second webpage. In some embodiments, the session data entity comprises: (a) an ordered sequence of a plurality of captured page images that (i) were captured during the session, and (ii) correspond to a plurality of webpages visited by the end user during the session; and (b) a plurality of captured user interactions executed by the end user while interacting with the plurality of webpages.

The term “captured page image” may refer to an electronically-stored data construct that is configured to describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage (e.g., a subsequent webpage in the same website as the website of a current webpage or in a different website) after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are executed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are executed.

The term “captured user interaction” may refer to an electronically-stored data construct that is configured to describe a recorded/captured user action with respect to a segment of a webpage, where the captured user interaction may be described by a session data entity corresponding to a recorded/captured session that included executing the corresponding user action associated with the captured user interaction. In some embodiments, a captured user interaction describes: (i) an associated interactive page element within a corresponding webpage with respect to which the corresponding user action was executed during the recorded/captured session; (ii) a user action type of the corresponding user action with respect to the associated interactive page element within the corresponding webpage; and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction; and (ii) selecting (e.g., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction; (ii) typing (e.g., inputting text) as the user action type corresponding to the captured user interaction; and (iii) because the user action type of typing requires a user input value, the text input value “pshoghi” as the user input value for the captured user interaction. In some embodiments, a captured user interaction is associated with: (i) a captured page image; (ii) an interactive page element; and (ii) a set of action features. The captured page image for a captured user interaction may describe an image of a corresponding webpage with respect to which a user action corresponding to the captured user interaction is executed, while an interactive page element may describe an element (e.g., an interactive page element, a Hypertext Markup Language (HTML) element, and/or the like) of the corresponding webpage, where the user action corresponding to the captured user interaction is executed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include: (i) a user action type of a user action associated with the captured user interaction that may describe a general mode of user interaction with an interactive page element which may be defined based at least in part on an interactive page element type of the interactive page element; (ii) a user input value of a user action associated with the captured user interaction that may describe a finalized (rather than intermediate) value of a user action with respect to an interactive page element; (iii) a user action sequence identifier of a user action associated with the captured user interaction that may describe a temporal order of the user action within a set of sequential user actions executed with respect to interactive page elements of a webpage associated with the user action: (iv) a user action time of a user action associated with the captured user interaction that may describe a captured time of the corresponding user action, and/or the like.

The term “nestable automated testing workflow data entity” may refer to an electronically-stored data construct that is configured to describe an automated testing workflow data entity that may be integrated as unit into other automated testing workflow data entity, where modification of the nestable automated testing workflow data entity causes corresponding modifications for any automated testing workflow data entities that have integrated the nestable automated testing workflow data entity. The automated testing workflow data entities that have integrated a nestable automated testing workflow data entity are referred to as integrative automated testing workflow data entities for the nestable automated testing workflow data entities. In some embodiments, to integrate the modifications to a nestable automated testing workflow data entity into the integrative automated testing workflow data entities that are associated with the nestable automated testing workflow data entity, a computing entity may: (i) detect one or more nestable workflow modifications for the nestable automated testing workflow data entity, wherein the nestable automated testing workflow data entity is associated with a plurality of nestable captured page images and a plurality of nestable automated testing workflow steps; and (ii) for each integrative automated testing workflow data entity: determine a target image subset of a plurality of captured page images of the integrative automated testing workflow data entity that correspond to the plurality of nestable captured page images, determine a target step subset of a plurality of a plurality of automated testing workflow steps of the integrative automated testing workflow data entity that correspond to the plurality of nestable automated testing workflow steps, and update each captured page image in the target image subset and each automated testing workflow step in the target step subset based at least in part on the one or more nestable workflow modifications. In some embodiments, as used herein, a nestable interactive page element is an interactive page element of a captured page image of a nestable automated testing workflow data entity. In some embodiments, while a first nestable automated testing workflow data entity can be integrated into a second nestable automated testing workflow data entity, if such an integration exists, then the second nestable automated testing workflow data entity cannot be integrated into the first nestable automated testing workflow data entity, thus forbidding circular integration of automated testing workflow data entities.

The term “nestable workflow modification” may refer to an electronically-stored data construct that is configured to describe a change to at least one of: (i) the set of nestable captured page images of the nestable automated testing workflow data entity, or (ii) the set of nestable automated testing workflow steps for the nestable automated testing workflow data entity. For example, with respect to a nestable automated testing workflow data entity that describes a set of nestable automated testing workflow steps for a nestable captured page image of a login webpage that includes a nestable automated testing workflow step associated with typing a username, a nestable automated testing workflow step associated with typing a password, and a nestable automated testing workflow step associated with selecting a login button, a nestable workflow modification may describe that the set of nestable automated testing workflow steps the nestable automated testing workflow data entity include selecting a “remember username” button. As another example, with respect to a nestable automated testing workflow data entity that describes a set of nestable automated testing workflow steps logging into a system via a login webpage, a nestable workflow modification may describe a new captured page image that describe a new configuration of the login webpage. As yet another example, with respect to a nestable automated testing workflow data entity that describes a set of nestable automated testing workflow steps logging into a system via a login webpage, a nestable workflow modification may describe a new captured page image that describe a new configuration of the login webpage along with a new set of nestable automated testing workflow steps for the noted new captured page image.

The term “output parameter” may refer to an electronically-stored data construct that is configured to describe a value that is determined based at least in part on a user input value for an automated testing workflow data entity test step that corresponds to an interactive page element of a corresponding nestable automated testing workflow data entity, where the value is configured to be used to determine a value of an input parameter of another nestable automated testing workflow data entity. For example, in some embodiments, when two or more automated testing workflow data entities are integrated into a common destination automated testing workflow data entity, then an output parameter of a first nestable of the two or more automated testing workflow data entities may be passed to one or more input parameters of one or more second automated testing workflow data entities of the two or more automated testing workflow data entities.

The term “input parameter” may refer to an electronically-stored data construct that is configured to describe a value that is used to determine a user input value for an automated testing workflow data entity test step that corresponds to an interactive page element of a corresponding nestable automated testing workflow data entity, where the value is determined based at least in part on an output parameter of another nestable automated testing workflow data entity. For example, in some embodiments, when two or more automated testing workflow data entities are integrated into a common destination automated testing workflow data entity, then an output parameter of a first nestable of the two or more automated testing workflow data entities may be passed to one or more input parameters of one or more second automated testing workflow data entities of the two or more automated testing workflow data entities.

The term “workflow playback operation” may refer to an electronically-stored data construct that is configured to describe a computer-implemented operation that is configured to perform a captured user action associated with a corresponding automated testing workflow step within a web environment of the automated testing workflow data entity that comprises the corresponding automated testing workflow step. In some embodiments, executing a workflow playback operation comprises at least one of the following g: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; (iii) generating the success indicator for the workflow playback operation based at least in part on the modified web environment state for the automated testing workflow step; (iv) generating a captured page image of the web environment state before executing operations of the automated testing workflow step and the modified web environment state subsequent to executing operations of the automated testing workflow step; (v) if the workflow playback operation is associated with a negative success indicator, capturing the error type and/or the error description of the error associated with the workflow playback operation; and (vi) if the workflow playback operation is associated with a negative success indicator and the for the automated testing workflow step is associated with an assertion, capturing the reason for the failure of the assertion (e.g., unable to locate a particular value, found a different value instead of an expected value, and/or the like).

The term “success indicator” may refer to an electronically-stored data construct that is configured to describe a value that is configured to describe whether a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step. In some embodiments, if a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a positive value. In some embodiments, if a corresponding workflow playback operation associated with a corresponding automated testing workflow step has not successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a negative value. In some embodiments, the success indicator for a workflow playback operation that is associated with an automated testing workflow step may be negative if one of the following conditions is satisfied: (i) no interactive page element is detected at a page region of a corresponding webpage that is determined in accordance with the element location data for the automated testing workflow step; or (ii) an interactive page element is detected at a page region of a corresponding webpage that is determined in accordance with the element location data for the automated testing workflow step, but the detected interactive page element has an element type that is inconsistent with an element type of an interactive page element for the corresponding automated testing workflow step as determined in accordance with the element type data for the automated testing workflows step.

The term “execution log” (which may also be referred to as “results,” “test results,” “playback results,” and/or the like) may refer to an electronically-stored data construct that is configured to describe at least one success indicator associated with a workflow playback operation of the required number of workflow playback operations. In some embodiments, the execution log describes an affirmative execution log field (e.g., indicating success of a corresponding workflow playback operation) for each automated testing workflow step that is associated with the required number of workflow playback operations other than the terminal workflow playback operation. In some embodiments, the execution log describes a negative execution log field (e.g., indicating failure of a corresponding workflow playback operation) for the target automated testing workflow step that is associated with terminal workflow playback operation. In some embodiments, user selection of the negative execution log causes generating user interface data for a workflow step action feature element that is associated with the target automated testing workflow step. In some embodiments, modifying the target automated testing workflow step can be performed via user interaction with the workflow step action feature element. In some embodiments, if an automated testing workflow data entity integrates a nestable automated workflow data entity, and further if a nestable automated workflow step associated with the integrated nestable automated workflow data entity is associated with a negative success indicator, then the execution log will associate the error for the nestable automated workflow step with the integrated nestable automated workflow data entity rather than with the integrating automated testing workflow data entity. In some of the noted embodiments, user selection of the execution log may cause generating user interface data for the integrated nestable automated workflow data entity that is augmented with the error information for the error-prone nestable automated workflow step. In some embodiments, if an automated testing workflow step that is associated with a negative success indicator is within a loop, then the execution log will indicate how many successful iterations of the loop have completed successfully and highlight the failed automated testing workflow step within the iteration loop where the failure occurred. In some embodiments, user interaction with the execution log for an automated testing workflow step that is associated with a negative success indicator enables comparing the captured page image for the automated testing workflow step to a corresponding original captured page image to facilitate analysis of the results described by the execution log.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more some embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

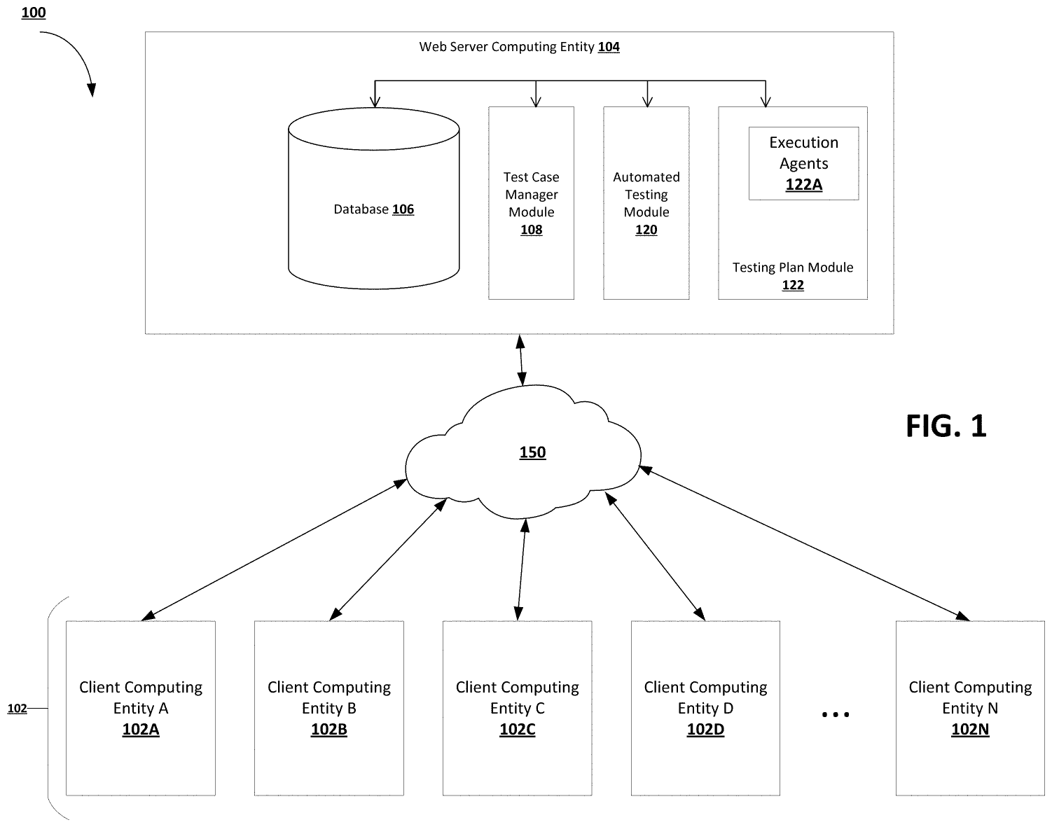

FIG. 1 is a schematic diagram of an example system architecture 100 for visually documenting a software testing operation and generating an automated testing workflow data entity. The system architecture 100 comprises a plurality of client computing entities 102 and a multi-tenant cloud architecture characterized by a web server computing entity 104, where the web server computing entity 104 comprises a database 106, a test case manager module 108, an automated testing module 120, and a testing plan module 122.

In some embodiments, the web server computing entity 104 may be made available as a “Software-as-a-Service” framework to multiple end users through the multi-tenant cloud architecture. In some embodiments, the multiple end users may each use a client computing entities 102A-N to connect (through the web server computing entity 104) to the multi-tenant cloud architecture to cause execution of one or more software testing operations associated with the web server computing entity 104. The web server computing entity 104 may allow communication between client computing entities 102A-N via one or more communication networks 150. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The web server computing entity 104 may be configured to enable generating visual documentation for a software testing operation and executing the software testing operation based at least in part on the visual documentation. The visual documentation for a software testing operation may be referred to as a “test case data entity” herein. The web server computing entity 104 may be configured to enable modifying test case data entities, integrating test case data entities across test case libraries, manually executing test case data entities, automatically executing automation scripts corresponding to test case data entities, and/or the like.

The web server computing entity 104 may further be configured to generate sequences of web-based actions that may be executed in order to automatically software testing operations. Such defined sequences of web-based actions may be referred to as “automated testing workflow data entities” herein. The web server computing entity 104 may be configured to enable modifying automated testing workflow data entities, integrating automated testing workflow data entity into other automated testing workflow data entities, automatically execution automation scripts corresponding to the automated testing workflow data entities, and/or the like.

The web server computing entity 104 may further be configured to generate automation scripts for automated testing workflow data entities. Such automation scripts are referred to as “automated testing plan data entities” herein. The web server computing entity 104 may be configured to enable modifying automated testing plan data entities, executing corresponding sequences of web-based actions in accordance with automated testing plan data entities, and/or the like.

The web server computing entity 104 may comprise a test case manager module 108, an automated testing module 120, and a testing plan module 122. The test case manager module 108 may be configured to enable generating test case data entities, modifying test case data entities, integrating test case data entities across test case libraries, manually executing test case data entities, automatically executing automation scripts corresponding to test case data entities, and/or the like.

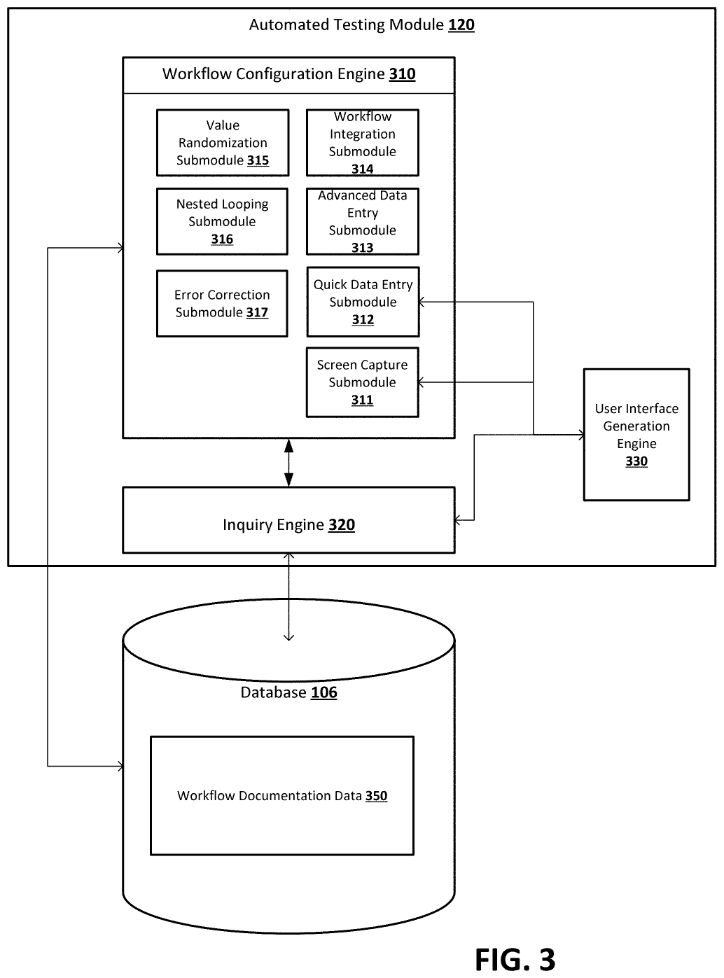

The automated testing module may be configured to enable generating automated testing workflow data entities, modifying automated testing workflow data entities, integrating automated testing workflow data entity into other automated testing workflow data entities, automatically execution automation scripts corresponding to the automated testing workflow data entities, and/or the like. An operational example of an automated testing module 120 is depicted in FIG. 3.

The testing plan module 122 may be configured to enable generating automated testing plan data entities, modifying automated testing plan data entities, executing corresponding sequences of web-based actions in accordance with automated testing plan data entities, and/or the like. The testing plan module 122 comprises a set of execution agents 122A that are configured to execute corresponding sequence of web-based actions defined by automated testing workflow data entities in accordance with the automation scripts for the noted automated testing workflow data entities as defined by the automated testing plan data entities for the noted automated testing plan data entities.

The database 106 may include one or more storage units, such as multiple distributed storage units that are connected through a computer network. The database 106 may store data using one or more non-volatile storage or memory median including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Web Server Computing Entity

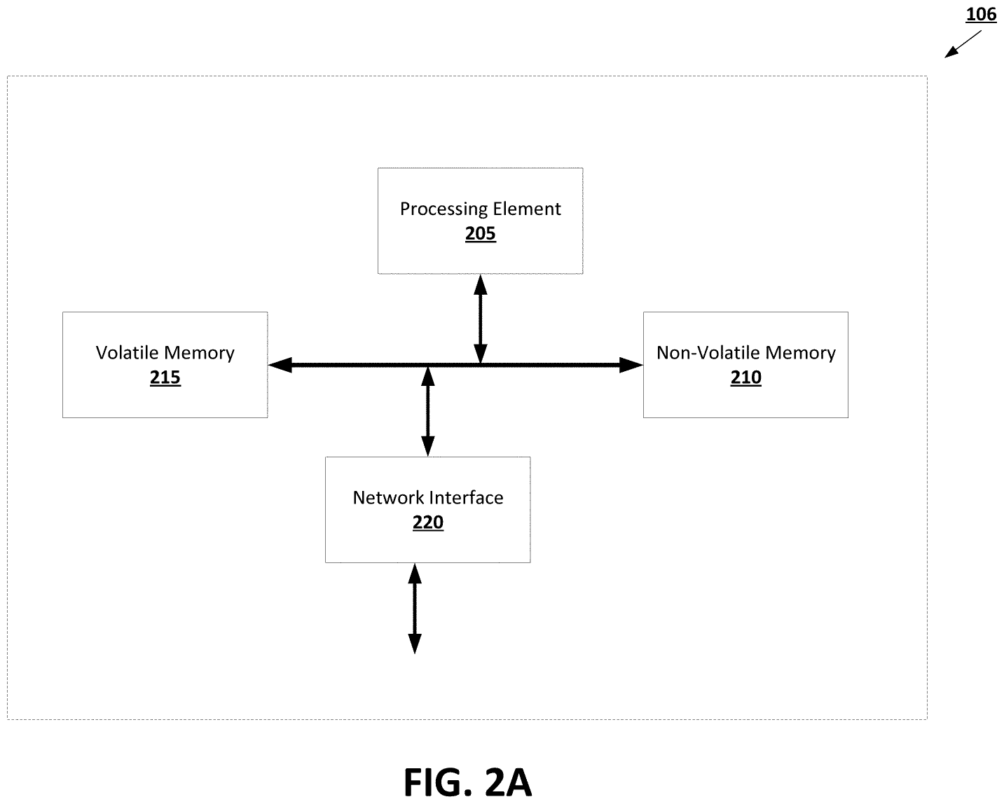

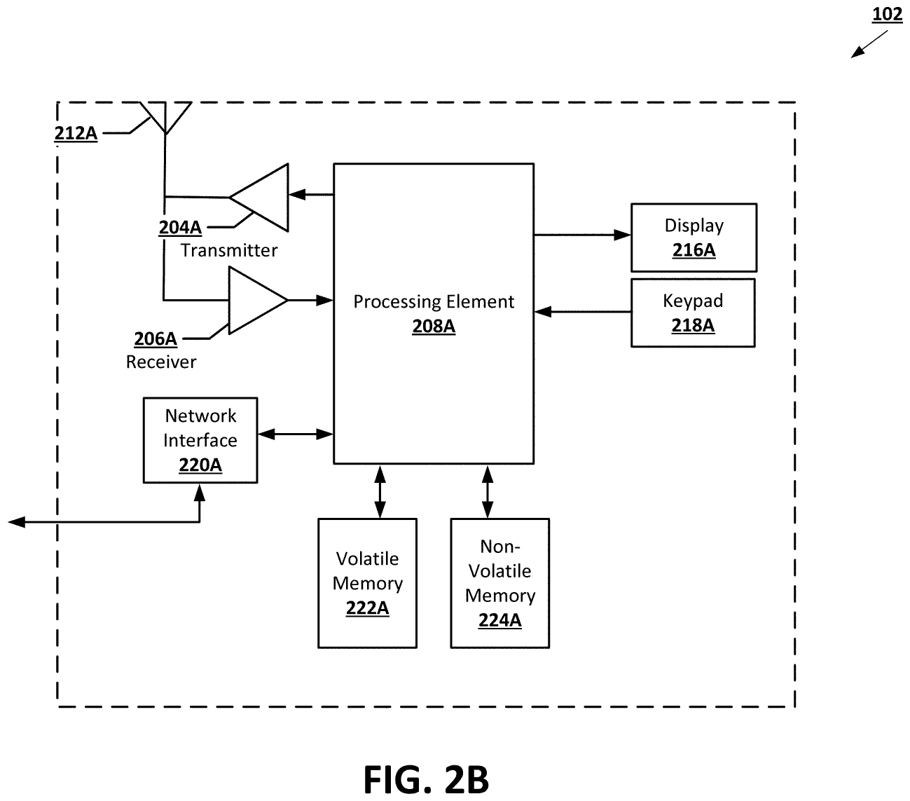

FIG. 2A provides a schematic of a web server computing entity 104 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably.

As indicated, in one embodiment, the web server computing entity 104 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 104 may include, or be in communication with, one or more processing elements 205 (also referred to as processors, processing circuitry, and/or similar terms used herein interchangeably) that communicate with other elements within the web server computing entity 104 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 104 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the web server computing entity 104 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 104 with the assistance of the processing element 205 and operating system.

As indicated, in one embodiment, the web server computing entity 104 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 104 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 104 may include, or be in communication with, one or more input elements, such as a keyboard input, a mouse input, a touch screen/display input, motion input, movement input, audio input, pointing device input, joystick input, keypad input, and/or the like. The web server computing entity 104 may also include, or be in communication with, one or more output elements (not shown), such as audio output, video output, screen/display output, motion output, movement output, and/or the like.

### Exemplary Client Computing Entity

FIG. 2B provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Client computing entities 102 can be operated by various parties. As shown in FIG. 3, the client computing entity 102 can include an antenna 212A, a transmitter 204A (e.g., radio), a receiver 206A (e.g., radio), and a processing element 208A (e.g., CPLDs, microprocessors, multi-core processors, coprocessing entities, ASIPs, microcontrollers, and/or controllers) that provides signals to and receives signals from the transmitter 204A and receiver 206A, correspondingly.

The signals provided to and received from the transmitter 204A and the receiver 206A, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 104. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 104 via a network interface 220A.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 216A coupled to a processing element 208A) and/or a user input interface (coupled to a processing element 208A). For example, the user interface may be a user application, browser, user interface, and/or similar words used herein interchangeably executing on and/or accessible via the client computing entity 102 to interact with and/or cause display of information/data from the web server computing entity 104, as described herein. The user input interface can comprise any of a number of devices or interfaces allowing the client computing entity 102 to receive data, such as a keypad 218A (hard or soft), a touch display, voice/speech or motion interfaces, or other input device. In embodiments including a keypad 218A, the keypad 218A can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 222A and/or non-volatile storage or memory 224A, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 104 and/or various other computing entities.

In another embodiment, the client computing entity 102 may include one or more components or functionality that are the same or similar to those of the web server computing entity 104, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Local, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary Automated Testing Module

FIG. 3 provides an operational example of an automated testing module 120. The automated testing module 120 comprises an inquiry engine 320, a user interface generation engine 330, and a workflow configuration engine 310.

The user interface generation engine 330 is configured to receive user requests for generating, modifying, or accessing automated testing workflow data entities from client computing entities 102 and provide the noted user requests to the inquiry engine 320. The user interface generation engine 330 is further configured to generate any data outputs transmitted, by the inquiry engine 320 and to the user interface generation engine 330, in response to a user request to the client computing entity 102 that is associated with the user request. For example, if a user request is associated with accessing an automated testing workflow data entity, the user interface generation engine 330 may be configured to receive the user request from the client computing entity 102 that is associated with the user request, provide the user request to the inquiry engine 320, receive a data output describing the automated testing workflow data entity in response to the user request from the inquiry engine 320, generate automated testing workflow visualization user interface data for an automated testing workflow visualization user interface based at least in part on the data output describing the automated testing workflow data entity, and provide the automated testing workflow visualization user interface data to the client computing entity associated with the user request.

The inquiry engine 320 is configured to process user requests by interacting with at least one of the workflow documentation data 350 in the database and the workflow configuration engine 310. For example, the inquiry engine 320 may be configured to: (i) provide requests for generating or modifying automated testing workflow data entities to the workflow configuration engine 310, and (ii) provide requests for access automated testing workflow data entities to the workflow configuration engine 310. The inquiry engine 320 may be further configured to generate output data describing automated testing workflow data entities to the user interface generation engine 330, where the user interface generation engine 330 may in turn utilize the noted output data to generate automated testing workflow visualization user interface data for automated testing workflow visualization user interfaces that may then be transmitted to client computing entities 102 associated with user requests.

The workflow configuration engine 310 may be configured to enable generating and modifying automated testing workflow data entities. For example, the workflow configuration engine 310 may enable generating or modifying automated testing workflow data entities using at least one of screen capture techniques, quick data entry techniques, advanced data entry techniques, integrating one or more nestable automated testing workflow data entities into the automated testing workflow data entity, web-based actions defined by randomized data value entry into interactive page elements of webpages, web-based actions defined by nested looping structures, and in accordance with user-requested modifications generated based at least in part on automatically-detected automated testing workflow errors. Once generated or modified by the workflow configuration engine 310, the workflow configuration engine 310 may store a resulting automated testing workflow data entity as part of the workflow documentation data 350 that is stored on the database 106 (e.g., a relational database). In some embodiments, the quick data entry techniques enabled by the workflow configuration engine 310 accelerates the ability for a user to populate the data fields for one or more automated testing workflow steps within an automated testing workflow data entity.

The workflow configuration engine 310 comprises the screen capture submodule 311, the quick data entry submodule 312, the advanced data entry submodule 313, the workflow integration submodule 314, the value randomization submodule 315, the nested looping submodule 316, and the error correction submodule 317.

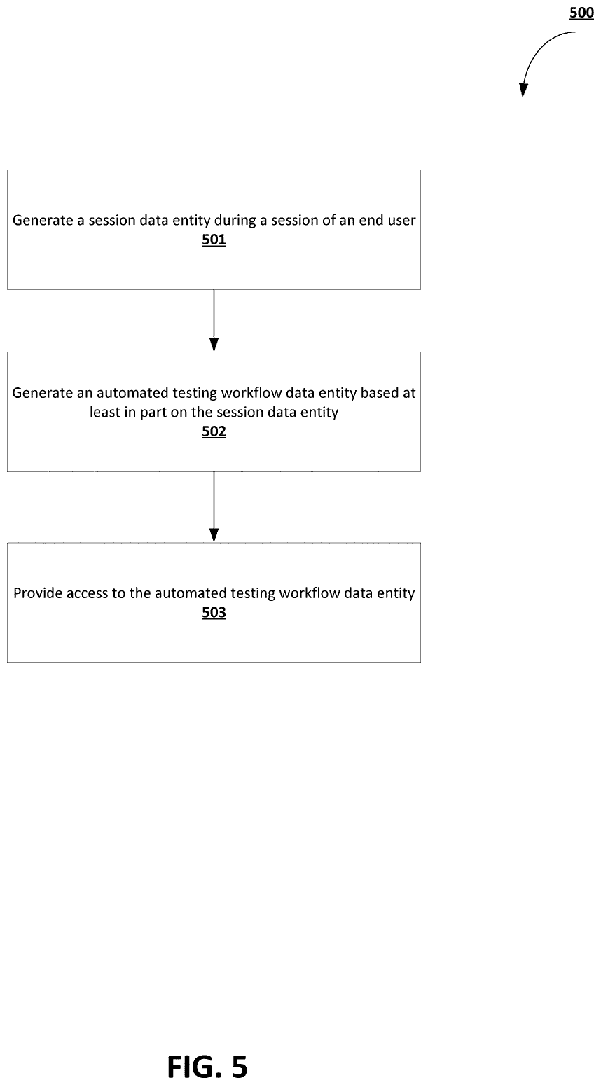

The screen capture submodule 311 is configured to enable generating or modifying automated testing workflow data entities using screen capture technologies described below. In some embodiments, the screen capture submodule 311 is configured to perform at least some of the steps/operations of the process 500 of the FIG. 5 described below.

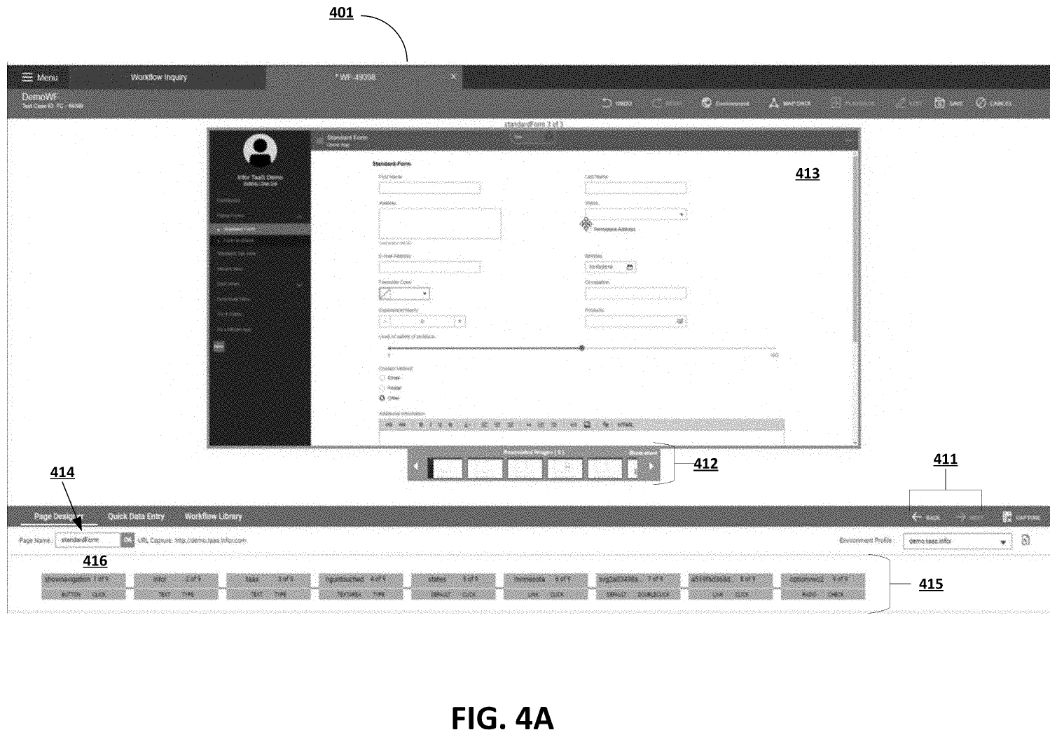

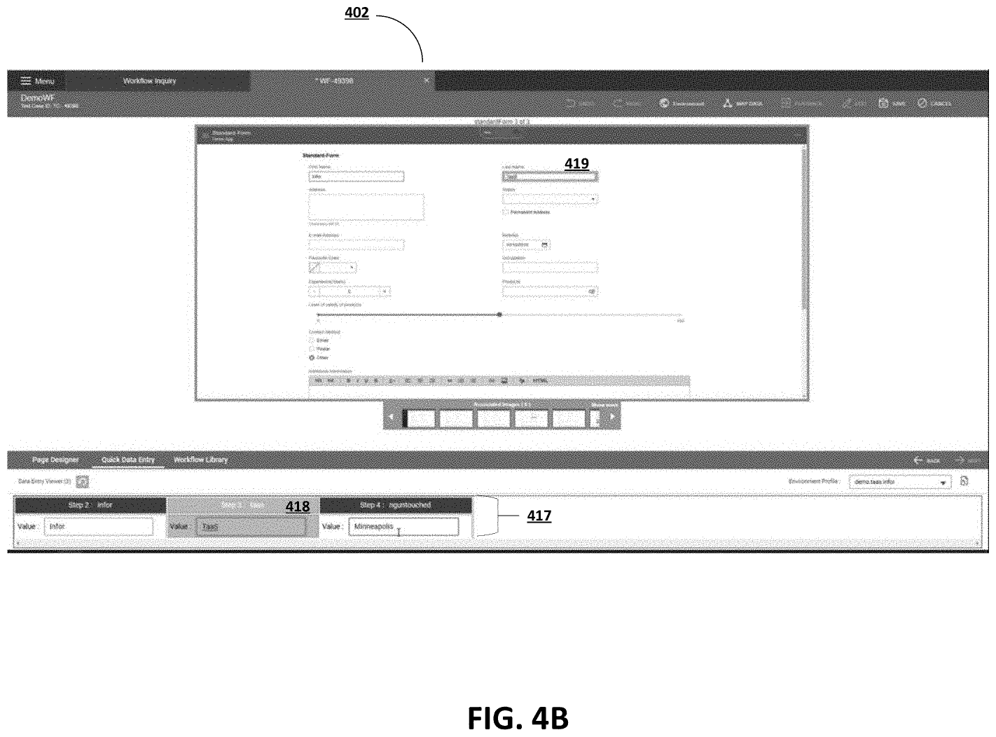

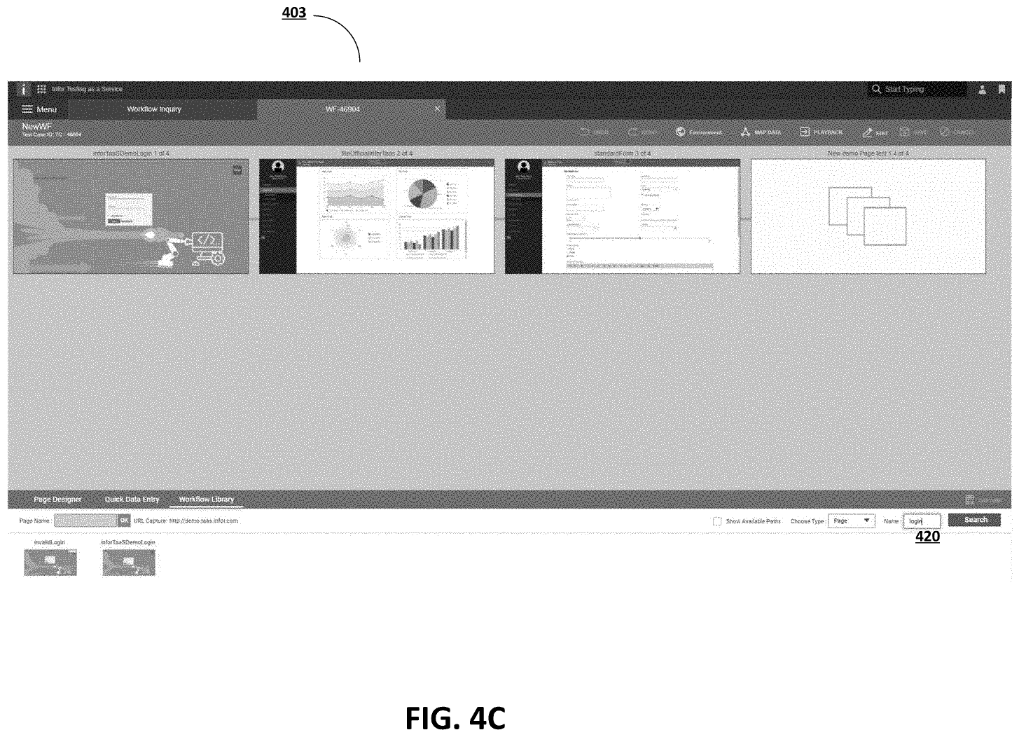

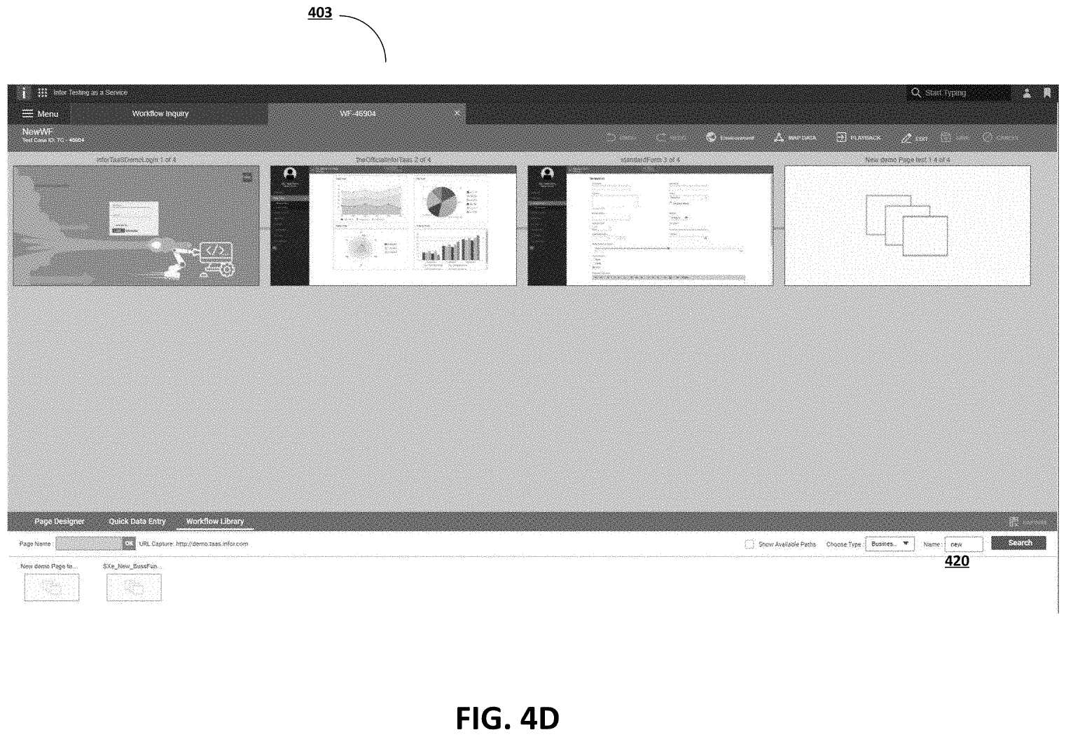

The quick data entry submodule 312 is configured to enable modifying user input values for automated testing workflow steps using quick data entry elements. Aspects of the operations of the quick data entry submodule 312 are described below with reference to the automated testing workflow visualization user interface 402 of FIG. 4B.

The advanced data entry submodule 313 is configured to enable modifying automated testing workflow data entities using a structured data file that includes, for each of the automated testing workflow steps of an automated testing workflow data entity, features associated with the automated testing workflow steps. An example of a structured data file is an Excel file.

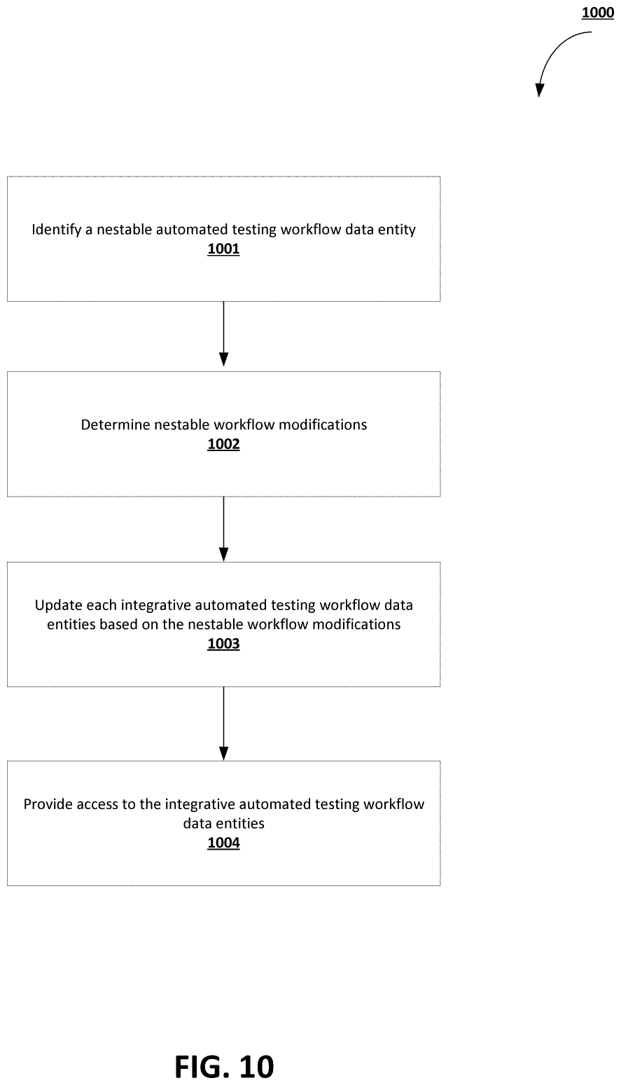

The workflow integration submodule 314 is configured to enable integrating nestable into integrative modifying automated testing workflow data entities and mapping parameters of two or more nestable modifying automated testing workflow data entities that are mapped to the same integrative modifying automated testing workflow data entity. Aspects of the steps/operations of the workflow integration submodule 314 are described in FIG. 10.

The value randomization submodule 315 is configured to generate random values that may be supplied as user input values for automated testing workflow steps of automated testing workflow data entities. In some embodiments, the value randomization submodule 315 may generate the random values based at least in part on randomization parameters provided to the value randomization submodule 315.

The nested looping submodule 316 is configured to generate looping structures that may be supplied as automated testing workflow steps of automated testing workflow data entities. For example, a looping structure may require a set of login actions to be done a defined number of times. In some embodiments, the nested looping submodule 316 may generate the looping structures provided as part of the automated testing workflow steps of the automated testing workflow data entities based at least in part on looping parameters provided to the nested looping submodule 316.

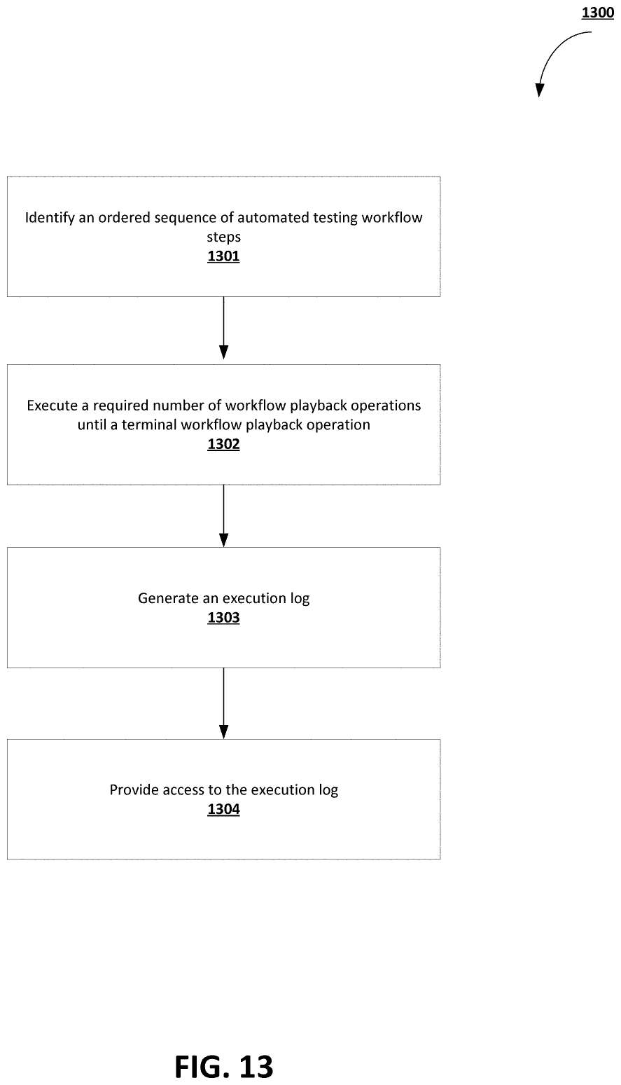

The error correction submodule 317 is configured to detect automated testing workflow steps that are not associated with proper interactive page elements and thus need to be updated. Such detections may be provided as an execution log for a set of workflow playback operations corresponding to the automated testing workflow test steps of an automated testing workflow data entity. Aspects of the steps/operations of the error correction submodule 317 is described with reference to process 1300 of FIG. 13.

### Exemplary System Operations

Various embodiments of the present invention describe innovative and technologically advantageous techniques for managing automated testing workflow data entities, including for generating automated testing workflow data entities, for modifying automated testing workflow data entities, and for integrating nestable automated testing workflow data entities into other automated testing workflow data entities. Before proceeding to describe the noted techniques, however, we have provided descriptions of exemplary features of various components of automated testing workflow data entities, including captured page images and automated testing workflow steps, as well as how those components can be used to generate automated testing workflow visualization user interfaces, such as the automated testing workflow visualization user interfaces 401-403 of FIGS. 4A-4D.

In general, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

In some embodiments, an automated testing workflow data entity depicts a set of captured page images corresponding to the sequence of webpages associated with the corresponding software testing operation. A captured page image may describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are executed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are executed.

In some embodiments, a webpage associated with an automated testing workflow data entity may be associated with more than one captured page image. In some embodiments, a software component (e.g., a web browser extension) that is configured to generate session data entities may detect presence of particular expandable interactive page elements within a visited webpage elements within a visited webpage and, upon detection of user interactions configured to expand an expandable interactive page element, generate a captured page image based at least in part on a screenshot of the visited webpage during a visual state in which the expandable interactive page element is in an expanded state. For example, consider a webpage that includes a dropdown menu interactive page element. In the noted example, some captured page images associated with the webpage may depict a visual state of the webpage in which the dropdown menu interactive page element is in a non-expanded state. In some embodiments, upon detection of a user interaction that is configured to expand the dropdown menu interactive page element, a software component (e.g., a web browser extension) that is configured to generate session data entities may generate a screenshot of a visual state of the webpage in which the dropdown menu interactive page element is in a non-expanded state, and use the generated screenshot to generate an alternative captured page image for the particular webpage. In some embodiments, a software component (e.g., a web browser extension) that is configured to generate a session data entity may detect transitory display of particular transitory outputs (e.g., notifications) in relation to a visited webpage. In some of the noted embodiments, the noted software component may generate a screenshot of the visited webpage during a transitory display of a particular transitory output (e.g., a particular notification) and use the generated screenshot to generate an alternative captured page image for the particular visited webpage.

In some embodiments, the automated testing workflow data entity may define, for each captured page image associated with an automated testing workflow data entity (e.g., a captured page image that may be associated with a user-defined custom page label), a set of automated testing workflow steps. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; and (iii) a user action sequence identifier of the user action that may describe a temporal order of the user action within a set of sequential user actions executed with respect to interactive page elements of a webpage associated with the user action.

As described above, an automated testing workflow data entity may be used to generate an automated testing workflow visualization user interface, such as the automated testing workflow visualization user interface 401-403 of FIGS. 4A-4D. As depicted in FIG. 4A, the automated testing workflow visualization user interface 401, for a current webpage of a corresponding automated testing workflow data entity that is selected using the webpage selection buttons 411, a set of captured page images 412, such as the currently-displayed captured page image 413. The automated testing workflow visualization user interface 401 further depicts a user-assigned webpage label 414 of the current webpage, as well as a set of workflow step action feature elements 415, such as the workflow step action feature element 416, where each workflow step action feature element describes and enables modifying a set of user action features associated with a corresponding automated testing workflow step. For example, the workflow step action feature element 416 describes the following user action features for a corresponding automated testing workflow step: a user-defined step label of “shownavigation,” a user action feature sequence number of one (out of nine), an interactive page element type of button, and a user action type of selecting. Moreover, interacting with the workflow step action feature element 416 enables modifying the user action features associated with the corresponding automated testing workflow step as well as highlighting an image region of the currently-displayed captured page image 413 that corresponds to the interactive page element for the corresponding automated testing workflow step. In some embodiments, the automated testing workflow visualization user interface 401 enables at least one of adding captured page images to a corresponding automated testing workflow data entity, removing captured page images from the corresponding automated testing workflow data entity, and re-ordering automated testing workflow steps associated with the corresponding automated testing workflow data entity.

As further depicted in FIG. 4A, the automated testing workflow visualization user interface 401 enables, via interacting with an image region of the currently-displayed captured page image 413 corresponding to an interactive page element of the current webpage: (i) if the interactive page element is not currently associated with an automated testing workflow step, generating a new workflow step action feature element corresponding to a new automated testing workflow step that is associated with the interactive page element; and (ii) if the interactive page element is currently associated with an automated testing workflow step, highlighting the workflow step action feature element for the automated testing workflow step.

As depicted in FIG. 4B, the automated testing workflow visualization user interface 402 enables: (i) displaying quick data entry elements 417 corresponding to those automated testing workflow steps that are associated with user input values; and (ii) using each quick data entry element, modifying the user input value for the corresponding automated testing workflow step. As further depicted in FIG. 4B, user selection of a quick data entry element highlights the image region of the currently-displayed captured page image 413 corresponding to an interactive page element of the corresponding automated testing workflow step. For example, user selection of the quick data entry element 418 highlights the image region 419.

As depicted in FIG. 4C, the automated testing workflow visualization user interface 403, when in the “Page” type mode, enables searching for captured page images of non-nestable automated testing workflow data entities using the search panel 420 as well as adding selected captured page images to the automated testing workflow data entity that is associated with the automated testing workflow visualization user interface 403. A selected captured page image can either be added as a new image for an existing webpage associated with the automated testing workflow data entity that is already associated with one or more existing captured page images, or as a first image for a new webpage associated with the automated testing workflow visualization user interface 403.

As further depicted in FIG. 4D, the automated testing workflow visualization user interface 403, when in the “Business Function” type mode, enables searching for captured page images of nestable automated testing workflow data entities using the search panel 420 as well as adding selected captured page images to the automated testing workflow data entity that is associated with the automated testing workflow visualization user interface 403. As with FIG. 4C, a selected captured page image can either be added as a new image for an existing webpage associated with the automated testing workflow data entity that is already associated with one or more existing captured page images, or as a first image for a new webpage associated with the automated testing workflow visualization user interface 403.

### Generating Automated Testing Workflow Data Entities

In some embodiments, an automated testing workflow data entity may be generated and/or modified using screen capture techniques described below. In some embodiments, once created using screen capture techniques described below, a created automated testing workflow data entity may be modified using any of the techniques described herein for modifying automated testing workflow data entities. While various embodiments of the present invention describe techniques for generating automated testing workflow data entities using screen capture technologies described below, a person of ordinary skill in the relevant technology will recognize that the disclosed techniques can be used to modify an existing automated testing workflow data entity by generating new captured page images and/or new automated testing workflow steps for the existing automated testing workflow data entity.

FIG. 5 is a flowchart diagram of an example process 500 for generating an automated testing workflow data entity based at least in part on a session data entity. Via the various steps/operations of the process 500, the web server computing entity 104 can enable efficient and reliable generation of automated testing workflow data entities using session data entities that capture user interactions with an ordered sequence of captured page images.

The process 500 begins at step/operation 501 when the web server computing entity 104 generates a session data entity during a session of an end user. In some embodiments, the web server computing entity 104 utilizes one or more web browser extensions to capture user interactions with an ordered sequence of webpages and uses captured images corresponding to the ordered sequence and the captured user interactions to generate the session data entity.

In some embodiments, the session data entity may describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and selects a second designated button on the second webpage. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured; and (ii) for each webpage of the sequence of webpages, a set of user interactions executed in relation to the noted webpage. For example, for the exemplary session data entity described above, the session data entity may describe: (i) a sequence of webpages that describes that the first webpage was visited first and the second webpage was subsequently visited; (ii) for the first webpage, the user interactions corresponding to entering a text input in the first designated textbox on the first webpage, selecting the first designated checkbox on the first webpage, and selecting the first designated button on the first webpage; and (iii) for the second webpage, the user interactions corresponding to selecting the first designated radio button from the first designated set of related radio buttons on the second webpage and selecting the second designated button on the second webpage. In some embodiments, the session data entity comprises: (a) an ordered sequence of a plurality of captured page images that (i) were captured during the session, and (ii) correspond to a plurality of webpages visited by the end user during the session; and (b) a plurality of captured user interactions executed by the end user while interacting with the plurality of webpages.

A captured page image may describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are executed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are executed.

While various embodiments of the present invention describe session data entities in which a visited webpage is associated with a single captured page image, a person of ordinary skill in the relevant technology will recognize that in some embodiments a visited webpage may be associated with two or more captured page images. In some embodiments, a software component (e.g., a web browser extension) that is configured to generate a session data entity may detect presence of particular expandable interactive page elements within a visited webpage elements within a visited webpage and, upon detection of user interactions configured to expand an expandable interactive page element, generate a captured page image based at least in part on a screenshot of the visited webpage during a visual state in which the expandable interactive page element is in an expanded state. For example, consider a webpage that includes a dropdown menu interactive page element. In the noted example, some captured page images associated with the webpage may depict a visual state of the webpage in which the dropdown menu interactive page element is in a non-expanded state. In some embodiments, upon detection of a user interaction that is configured to expand the dropdown menu interactive page element, a software component (e.g., a web browser extension) that is configured to generate session data entities may generate a screenshot of a visual state of the webpage in which the dropdown menu interactive page element is in a non-expanded state, and use the generated screenshot to generate an alternative captured page image for the particular webpage. In some embodiments, a software component (e.g., a web browser extension) that is configured to generate a session data entity may detect transitory display of particular transitory outputs (e.g., notifications) in relation to a visited webpage. In some of the noted embodiments, the noted software component may generate a screenshot of the visited webpage during a transitory display of a particular transitory output (e.g., a particular notification) and use the generated screenshot to generate an alternative captured page image for the particular visited webpage.

As described above, a captured user interaction may describe a recorded/captured user action with respect to a segment of a webpage, where the captured user interaction may be described by a session data entity corresponding to a recorded/captured session that included executing the corresponding user action associated with the captured user interaction. In some embodiments, a captured user interaction describes: (i) an associated interactive page element within a corresponding webpage with respect to which the corresponding user action was executed during the recorded/captured session; (ii) a user action type of the corresponding user action with respect to the associated interactive page element within the corresponding webpage; and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction; and (ii) selecting (e.g., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction; (ii) typing (e.g., inputting text) as the user action type corresponding to the captured user interaction; and (iii) because the user action type of typing requires a user input value, the text input value “pshoghi” as the user input value for the captured user interaction.

Other examples of qualified user actions that can be associated with captured user interactions include: drag and drop actions, opening/closing tabs within a browser, file upload/download, browser actions (e.g., refreshing, clicking on a “back” button to get a previously-visited page, and/or the like), navigating to a new webpage, hotkey events (e.g., pressing at least one ctrl+a, ctrl+c, ctrl+z, etc.), and/or the like. In some embodiments, opening a tab can be performed in multiple ways. During a sequence of events within a session, the user may click to manually navigate to another web site via another browser tab, or the application itself may launch another webpage via another browser tab.

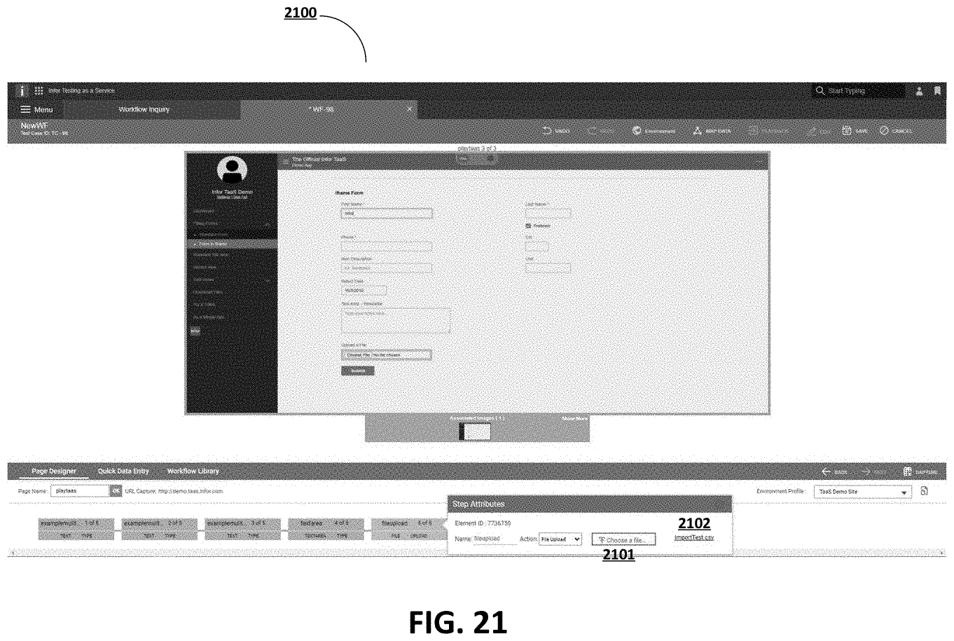

An operational example of an automated testing workflow visualization user interface 2100 that is used to define an automated testing workflow step for a file upload user action is depicted in FIG. 21. As depicted in FIG. 21, the automated testing workflow visualization user interface 2100 enables a file upload action using a file 2102 that is uploaded using the upload initiation user interface element 2101.

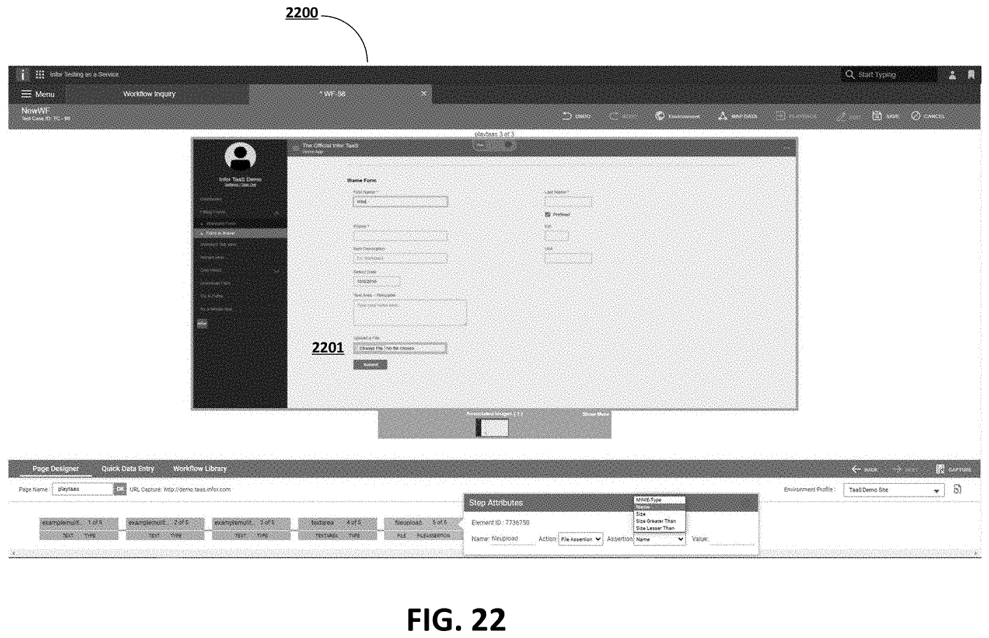

An operational example of an automated testing workflow visualization user interface 2200 that is used to define an automated testing workflow step for a file assertion user action is depicted in FIG. 22. As depicted in FIG. 22, the automated testing workflow visualization user interface 2200 enables a file assertion action on a file that is uploaded using the page element 2201 based on at least one of a media type of the file, a name of the file, or a size of the file.

In some embodiments, a captured user interaction is associated with: (i) a captured page image; (ii) an interactive page element; and (ii) a set of action features. The captured page image for a captured user interaction may describe an image of a corresponding webpage with respect to which a user action corresponding to the captured user interaction is executed, while an interactive page element may describe an element (e.g., an interactive page element, an HTML, element, and/or the like) of the corresponding webpage, where the user action corresponding to the captured user interaction is executed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include: (i) a user action type of a user action associated with the captured user interaction that may describe a general mode of user interaction with an interactive page element which may be defined based at least in part on an interactive page element type of the interactive page element; (ii) a user input value of a user action associated with the captured user interaction that may describe a finalized (rather than intermediate) value of a user action with respect to an interactive page element; and (iii) a user action sequence identifier of a user action associated with the captured user interaction that may describe a temporal order of the user action within a set of sequential user actions executed with respect to interactive page elements of a webpage associated with the user action.

As described above, the user input value of a captured user interaction may describe a finalized rather than an intermediate value of a user action associated with the user input value. This means that if, during the course of a session, an end user executes multiple conflicting actions with respect to an interactive page element, then only the final user action will be used to generate the user input value for a captured user inaction associated with the noted interactive page element. For example, consider a session during which an end user first selects a checkbox and then unselects the selected checkbox. In the noted example, a component (e.g., a web browser extension) that is configured to generate a session data entity for the session may not generate a captured user interaction for the noted conflicting actions with respect to the checkbox interactive page element. As another example, consider a session during which an end user first types “pshoghg” into a text box, then removes the final character of the noted text input and instead types an “i” character. In the noted example, a component (e.g., a web browser extension) that is configured to generate a session data entity for the session may generate a captured user interaction with respect to the text box that is associated with the user input value “pshoghi.” As yet another example, consider a session during which an end user first types “pshoghi” into a text box, then at a subsequent time prior to loading a subsequent webpage removes “pshoghi” from the text box and types “jbrown” instead. In the noted example, a component (e.g., a web browser extension) that is configured to generate a session data entity for the session may generate a captured user interaction with respect to the text box that is associated with the user input value “jbrown.” In some embodiments, the web server computing entity 104 is not a key logger and captures the totality of the final text entered by the user.

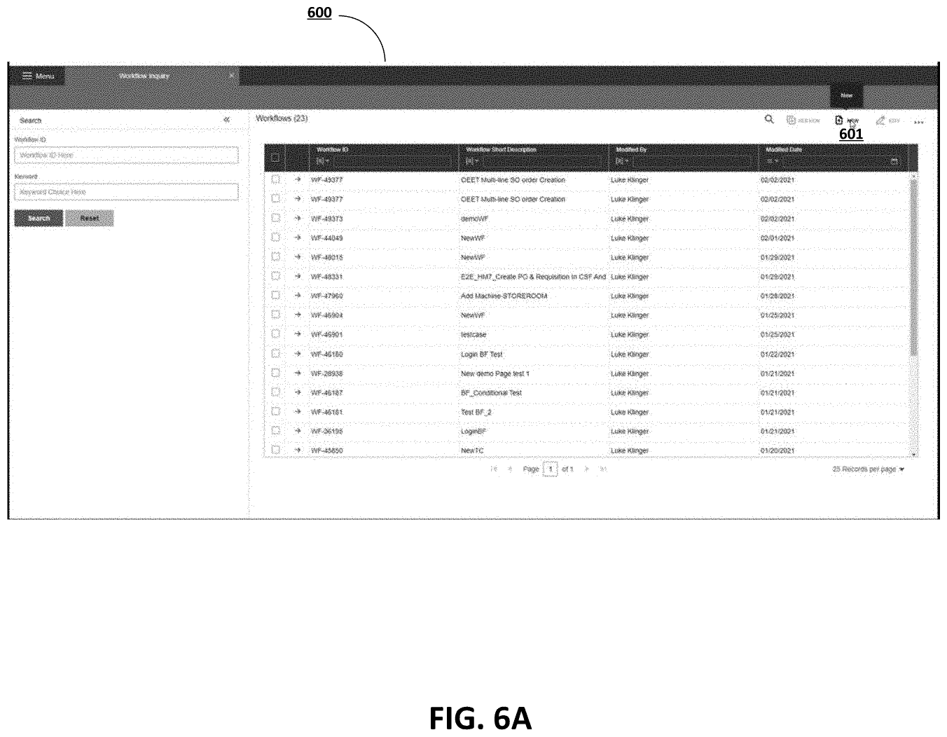

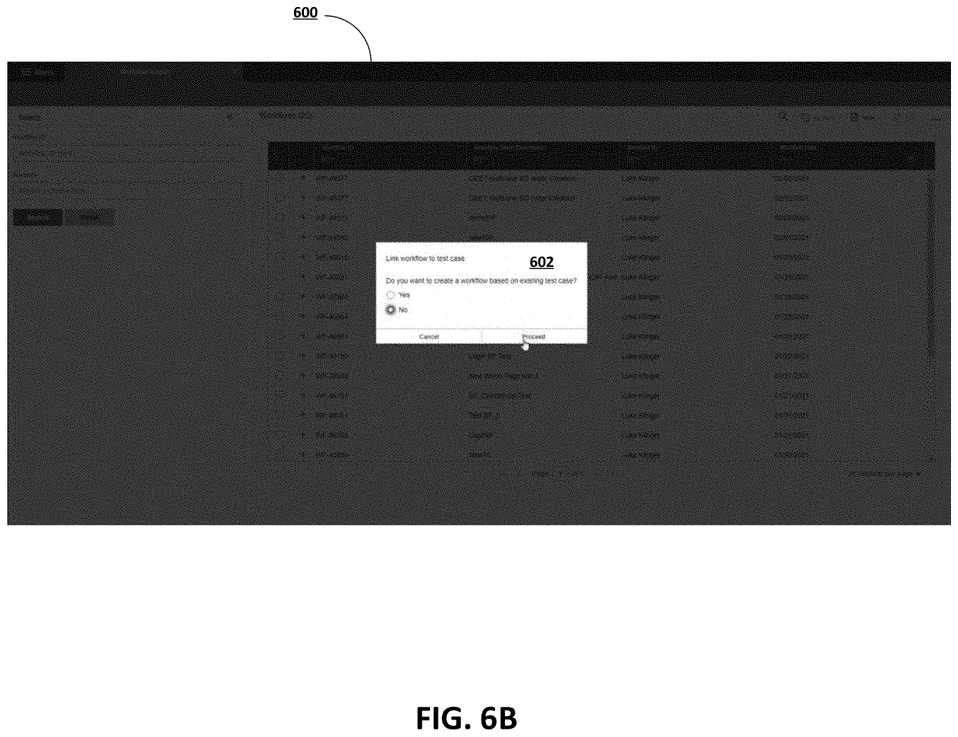

An operational example of user actions configured to generate a session data entity is depicted in FIGS. 6A-6B, FIG. 7, and FIGS. 8A-8C. As depicted in FIG. 6A, within the webpage 600, the user selects the button 601, a user action that leads to display of the page element 602 which enables the user to generate an automated testing workflow data entity based at least in part on a test case data entity. In some embodiments, an automated testing workflow data entity may be determined based at least in part on a test case data entity that is in turn generated based at least in part on a session data entity, as described below.

In general, a test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more test case page images associated with the test case; and (ii) for each test case page image of the one or more test case page images, a set of test case steps that relate to the test case page image. In some embodiments, the test case data entity contains data that can be used to generate a test case visualization user interface for the test case associated with the test case data entity, such as a test case visualization user interface that depicts: (i) one or more test case page images associated with the test case; and (ii) for each test case page image of the one or more test case page images, a set of test case visualizations corresponding to each test case step in the set of test case steps that relate to the particular test case page image.

A test case step may describe a user action required by a test associated with a corresponding test case data entity, where the user action may be executed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step; and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; and (iii) a user action sequence identifier of the user action that may describe a temporal order of the user action within a set of sequential user actions executed with respect to interactive page elements of a webpage associated with the user action.

In some embodiments, a test case data entity may be generated and/or modified using screen capture techniques. For example, in some embodiments, the web server computing entity 104 generates a test case data entity based at least in part on the session data entity. In some embodiments, the web server computing entity 104 uses the captured page images of the session data entity to generate the test case page images of the test case data entity, and uses the captured user interactions of the session data entity to generate test case steps associated with the test case page images of the test case data entity. In some embodiments, the test case data entity comprises: (i) a plurality of test case page images corresponding to the plurality of captured page images; and (ii) one or more test case steps associated with each of the plurality of test case page images.

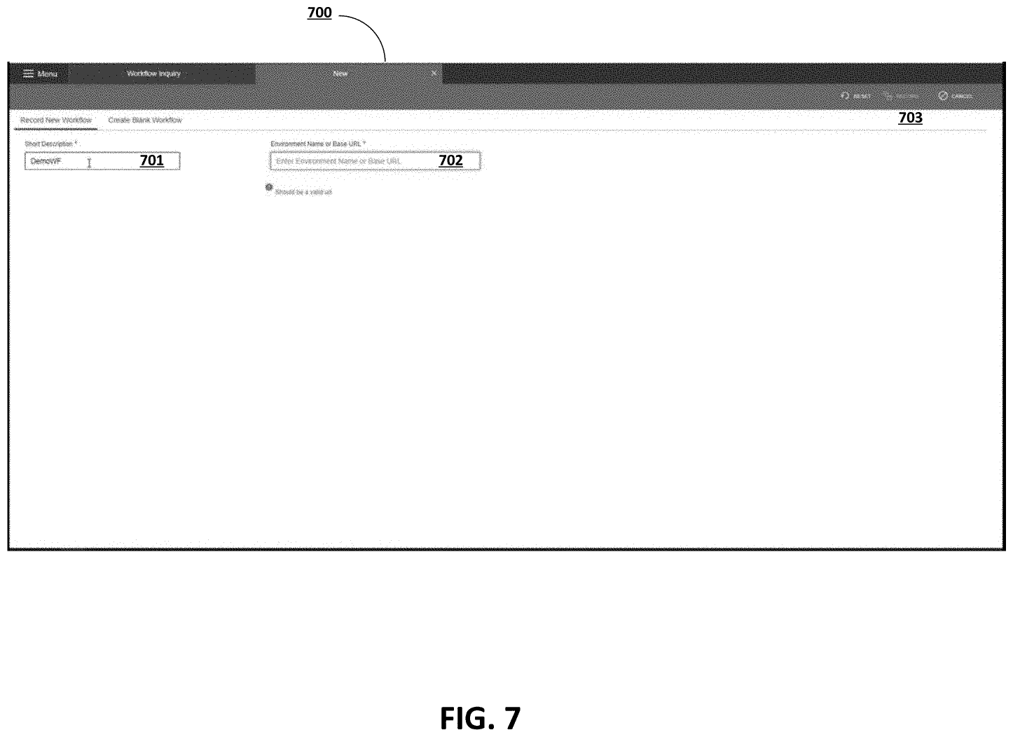

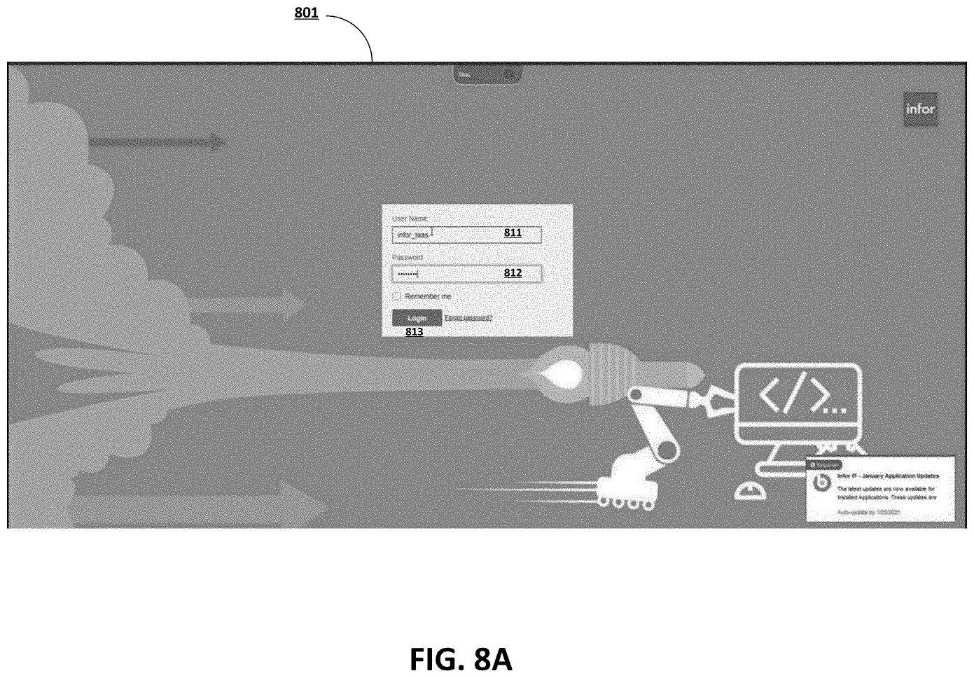

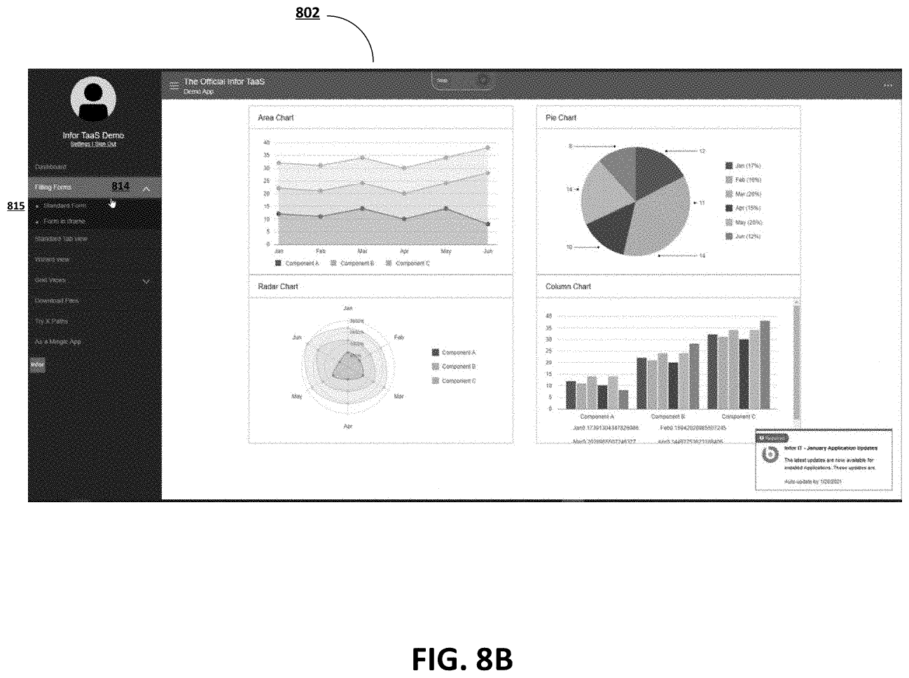

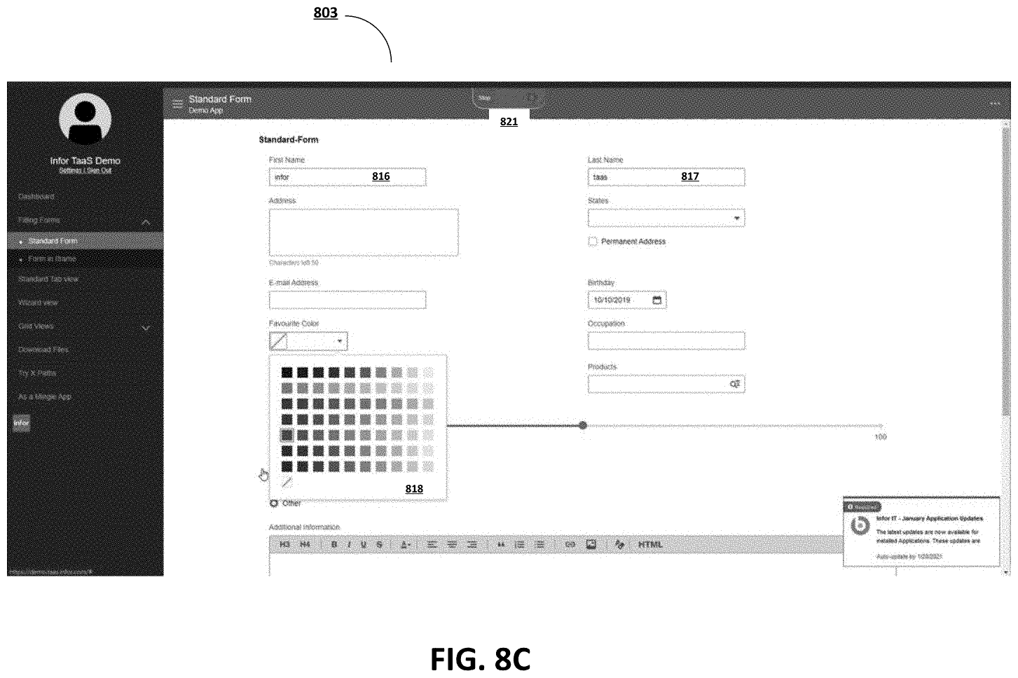

Assuming the user chooses to not generate an automated testing workflow data entity based at least in part on an existing test case data entity, the web server computing entity 104 may display user interface 700 of FIG. 7, which enables the user to define, via the page element 701, a short description of the automated testing workflow data entity, as well as provide a Uniform Resource Locator (URL) of the starting webpage for the automated testing workflow data entity using the page element 702. After providing the noted information, the user may select the button 703 to generate the session by lading the starting webpage, which leads to generating the webpage 801 of FIG. 8A and beginning of the captured session. In the particular session depicted using the FIGS. 8A-8C, user selection of the button 813 causes transition to the webpage 802 of FIG. 8B. Within the webpage 803, user interaction with the button 814 causes transition to the webpage 803 of FIG. 8C. Moreover, within webpage 803, user interaction with the button 821 causes termination of the session without transitioning from the webpage 803. During the session, within the webpages 801-803 of FIGS. 8A-8C, the user first types text into the textbox 811, then types text into the textbox 812, then selects the button 813, then selects the button 814, then selects the button 815, then types text into textbox 816, then types text into textbox 817, and then selects a color from the dropdown menu 818. The button 821 can be used to start recording, pause a recorded session, and end a recorded session. In some embodiments, during capturing of a session in order to generate a session data entity, a user can (e.g., via a set of operations comprising a right click operation and an operation associated with selection of a particular item) add assertions to enable the user assertions.

In some embodiments, the web server computing entity 104 can perform any of the following actions: (i) in a record mode, record a sequence of captured user actions and associated captured page images after the user selects to record, and (ii) in a capture mode, record captured page images and any element metadata for any interactive page elements within the webpage being captured after the user selects to capture. This facilitates capturing an image of a webpage where clicking the capture button itself may change the current state of the page. For example, if user clicks to open a dropdown and selects to capture the screen in this state, the nature of clicking the “capture” button would close the dropdown. Whereas, if the user clicks the “delayed capture” button, the user can then click to open the dropdown and have it in the “opened” state so the system will capture the page in the desired state at the end of the 5 second countdown. The capture mode may also enable the user to either capture a new image associated with an additional state of the webpage or replace an existing image with an updated image. This ‘replacement’ of a webpage is primarily used to facilitate when the application has changed something on the screen, thereby making the previous image obsolete, for example a new field being added or an old field being removed, or a button changed from “OK” to “Submit”.

In some embodiments, the session data entity generated based at least in part on the session depicted in FIGS. 8A-8C may be associated with captured page images that correspond to webpages 801-803 as well as the following captured user interactions: (i) a first captured user interaction associated with typing “infor_taas” into the textbox 811; (ii) a second captured user interaction associated with typing a password into the textbox 812; (iii) a third captured user interaction associated with selecting the button 813; (iv) a fourth captured user interaction associated with selecting the button 814; (v) a fifth captured user interaction associated with selecting the button 815; (vi) a sixth captured user interaction associated with typing “infor” into the textbox 816; (vii) a seventh captured user interaction associated with typing “taas” into the textbox 817; and (viii) an eighth captured user interaction associated with selecting the dark green color within the dropdown menu 818.

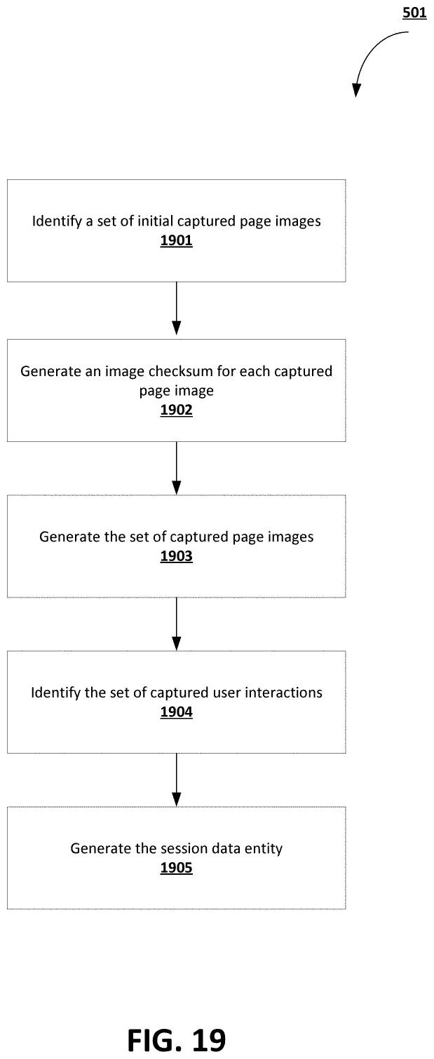

In some embodiments, step/operation 501 is executed in accordance with the process that is depicted in FIG. 19. The process that is depicted in FIG. 19 begins at step/operation 1901 when the web server computing entity 104 identifies a set of initial captured page images for a session of an end user. In some embodiments, a screen capture component (e.g., a web browser extension) that operates on a client computing entity 102 generates one or more screen capture data entities during the session and transmits the screen capture data entities to the web server computing entity 104. The screen capture data entities may be generated by the screen capture component when the end user is detected to have executed an interaction with a webpage during the session, where the initiation and the termination of the session may also be indicated by the end user (e.g., via interacting with buttons on a screen capture user interface displayed by the client computing entity 102).

A screen capture data entity may be any data entity that can be used to generate a captured page image. The screen capture data entities may comprise screenshots of a web browser interface using which the session is executed, where the screenshots can then be used by the web server computing entity 104 as the initial captured page images. The screen capture data entities may also include other data that can be used to generate initial captured page images by the web server computing entity 104, such as an HTML Document Object Model (DOM) file.

At step/operation 1902, the web server computing entity 104 determines, for each initial captured page image of the set of initial captured page images, an image checksum value. The image checksum value for a particular initial captured page image may be a value that may be used for verifying if another initial captured page image depicts the same webpage as the particular initial captured page image (e.g., a hashed representation of a webpage visual state described by the particular initial captured page image). In some embodiments, the screen capture component described above may generate the hashed representation and provide the hashed representation to the web server computing entity 104. In some embodiments, the web server computing entity 104 may determine the hashed representation based at least in part on a screen capture data entity (e.g., an HTML DOM file) provided by the client computing entity 102 and/or based at least in part on an initial captured page image generated by the web server computing entity 104 based at least in part on a screen capture data entity provided by the client computing entity 102. The image checksum value for an initial captured page image may describe a representation of the relative location of various interactive page element in the webpage corresponding to the initial captured page image and/or a representation of the states of various interactive page elements in the webpage, and may be determined based at least in part on the HTML data associated with the webpage.

At step/operation 1903, the web server computing entity 104 determines the set of captured page images based at least in part on each image checksum value for an initial captured page image. In some embodiments, to the extent the image checksum values for two or more initial captured page images describes that the two or more initial captured page images refer to the same webpage visual state, only one of the two or more initial captured page images is adopted among the set of captured page images. For example, if the set of initial captured page images for a session include C1-C3, where C1 and C2 have the same image checksum value, then the set of captured page images for the session may include C1 and C3.

At step/operation 1904, the web server computing entity 104 identifies the set of captured user interactions. In some embodiments, the screen capture component described above (which may, for example, be a JavaScript extension) attaches itself to listener methods of at least some of the page elements (e.g., a set of page elements that are deemed to be actionable page elements based at least in part on actionable page element detection rules associated with the screen capture component) in the HTML code of the webpages associated with the captured session, and then detecting the set of captured user interactions based at least in part on the data detected via listening to the listener methods. After detecting the captured user interactions, the screen capture component may transmit the noted captured user interactions to the web server computing entity 104. In some embodiments, the web server computing entity 104 identifies actionable page elements associated with a webpage based at least in part on a set of page elements that are associated with listener methods (e.g., JavaScript listener methods), as determined based on the HTML DOM for the webpage. In some embodiments, subsequent to beginning of recording of a session, a screen capture component (e.g., a web browser extension) injects event listeners into a webpage. If the event listener detects performance of an action, the screen capture component determines whether the webpage has a custom title defined. If the webpage has a custom title defined, the custom page title is adopted as a page title for the page; otherwise, default page title generation logics are used to generate the page title. Subsequent to determining the page title, the screen capture component generates a page checksum for the page based on the page title, generates a screenshot of the page, generates an image checksum for the webpage based on the visible page elements in accordance with the screenshots, collects any required metadata about the webpage, and sends the screenshot, the checksums, and the collected metadata to the web server computing entity 104. The web server computing entity 104 may be configured to determine if the page checksum exists in a page library. If the page checksum exists, the web server computing entity 104 identifies the existing page for the webpage and iterates over the page elements of the existing page to determine whether each page element exists, add location data for non-existent page elements, and replace location data of existing page elements. If the page checksum does not exist, the web server computing entity 104 creates a new page and adds elements (along with location data of the page elements) for the newly-added page. The web server computing entity 104 may further be configured to determine whether the image checksum exists. If the image checksum exists, the web server computing entity 104: (i) iterates over screen elements (i.e., page elements depicted by the corresponding screenshot) by determining whether each screen element exists and inserting new screen elements with coordinates for non-existent elements, and (ii) replaces element coordinates for existing screen elements if a coordinate checksum of the existing screenshot and a coordinate checksum of a new screenshot do not match. If the image checksum does not exist, the web server computing entity 104 saves the new screenshots with all corresponding screen element coordinates.

At step/operation 1905, the web server computing entity 104 generates the session data entity based at least in part on the set of captured page images and the set of captured user interactions. As described above, the session data entity may comprise: (a) an ordered sequence of a plurality of captured page images that (i) were captured during the session, and (ii) correspond to a plurality of webpages visited by the end user during the session; and (b) a plurality of captured user interactions executed by the end user while interacting with the plurality of webpages.

In some embodiments, subsequent to beginning of recording of a session, a screen capture component (e.g., a web browser extension) injects event listeners into a webpage. If the event listener detects performance of an action, the screen capture component determines whether the webpage has a custom title defined. If the webpage has a custom title defined, the custom page title is adopted as a page title for the page; otherwise, default page title generation logics are used to generate the page title. Subsequent to determining the page title, the screen capture component generates a page checksum for the page based on the page title, generates a screenshot of the page, generates an image checksum for the webpage based on the visible page elements in accordance with the screenshots, collects any required metadata about the webpage, and sends the screenshot, the checksums, and the collected metadata to the web server computing entity 104. The web server computing entity 104 may be configured to determine if the page checksum exists in a page library. If the page checksum exists, the web server computing entity 104 identifies the existing page for the webpage and iterates over the page elements of the existing page to determine whether each page element exists, add location data for non-existent page elements, and replace location data of existing page elements. If the page checksum does not exist, the web server computing entity 104 creates a new page and adds elements (along with location data of the page elements) for the newly-added page. The web server computing entity 104 may further be configured to determine whether the image checksum exists. If the image checksum exists, the web server computing entity 104: (i) iterates over screen elements (i.e., page elements depicted by the corresponding screenshot) by determining whether each screen element exists and inserting new screen elements with coordinates for non-existent elements, and (ii) replaces element coordinates for existing screen elements if a coordinate checksum of the existing screenshot and a coordinate checksum of a new screenshot do not match. If the image checksum does not exist, the web server computing entity 104 saves the new screenshots with all corresponding screen element coordinates.

Exemplary techniques for generating a session data entity with respect to a webpage are discussed below. To navigate to each iframe and capture page elements in each iframe along with the relative coordinates for the page elements: (i) if the iframes are in the same domain, then the iframes can be traversed through a tree traversal algorithm using an iframe hierarchy tree from a parent iframe, but (ii) if the iframes are in different domains, then a parent iframe can post a message asking for a list of elements in each child iframe (an action that can be performed by each iframe with respect to the children of the noted iframe) and then receive elements of in each child iframe in order to calculate absolute coordinates of the noted elements to post to a server endpoint along with screen captures. In some embodiments, to handle iframe switching, while recording a session, the screen capture component (e.g., a web browser extension) detects and records the iframe index that is relative to a root frame and collects other iframe information such as iframe names. In some embodiments, during a playback, the iframe names are matched with a loaded frame and if there are multiple iframes loaded with the same name, an approach using both iframe names and iframe indexes are used to detect proper iframes. In some embodiments, during a playback, the iframe names are matched with a loaded frame and if there is a single iframe with the iframe name, then that iframe is selected as the proper iframe. In some embodiments, to identify web browser actions (e.g., clicking on the web browser back button, clicking on the web browser forward button, and/or the like), the screen capture component (e.g., a web browser extension) collects and stores a list of URLs which the user navigated to during the recorded session. When the user performs a back or next actions, the screen capture component and/or the web server computing entity 104 compares the current URL with next URL and the previous URLs added to the list to determine whether the user has clicked on back or forward buttons. In some embodiments, to determine whether an interactive page element is accessible and not covered by another interactive page element, the screen capture component (e.g., a web browser extension) uses native JavaScript with a custom logic configured to determine whether the interactive page element is accessible and not covered by another interactive page element. In some embodiments, to determine when loading of a webpage has ended, the screen capture component (e.g., a web browser extension) processes the DOM of the webpage to identify one or more predefined custom busy indicators and only determines that the loading of the webpage has ended when all of the busy indicators disappear.

At step/operation 502, the web server computing entity 104 generates an automated testing workflow data entity based at least in part on the session data entity. In some embodiments, the web server computing entity 104 uses the captured user interactions of the session data entity to generate automated testing workflow steps associated with the captured page images of the automated testing workflow data entity, and combines the automated testing workflow steps along with the captured page images. In some embodiments, the automated testing workflow data entity comprises: (i) a plurality of captured page images; and (ii) one or more automated testing workflow steps associated with each of the plurality of captured page images.

An automated testing workflow step may describe a web-based action required by an automated testing workflow data entity, where the user action may be executed with respect to an interactive page element of a webpage associated with a captured page image of the corresponding automated testing workflow data entity. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step.

An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; and (iii) a user action sequence identifier of the user action that may describe a temporal order of the user action within a set of sequential user actions executed with respect to interactive page elements of a webpage associated with the user action.

For example, the session data entity generated based at least in part on the session depicted in FIGS. 8A-8C may be used to generate an automated testing workflow data entity that is in turn configured to describe: (i) a first captured page image corresponding to the webpage 801, a second captured page image corresponding to the webpage 802, and a third captured page image corresponding to the webpage 803; (ii) for the captured page image, a first automated testing workflow step for the first captured user interaction associated with typing “infor_taas” into the textbox 811, a second automated testing workflow step for the second captured user interaction associated with typing a password into the textbox 812, and a third automated testing workflow step for the third captured user interaction associated with selecting the button 813; (iii) for the second captured page image, a first automated testing workflow step for the fourth captured user interaction associated with selecting the button 814 and the fifth captured user interaction associated with selecting the button 815; and (iv) for the third captured page image, a first automated testing workflow step for the sixth captured user interaction associated with typing “infor” into the textbox 816, a second automated testing workflow step for the seventh captured user interaction associated with typing “taas” into the textbox 817, and a third automated testing workflow step for the eighth captured user interaction associated with selecting the dark green color within the dropdown menu 818.

At step/operation 503, the web server computing entity 104 provides access to the automated testing workflow data entity using an automated testing workflow visualization user interface. In some embodiments, the web server computing entity 104 generates an automated testing workflow visualization user interface data entity for the automated testing workflow visualization user interface and provides the automated testing workflow visualization user interface data entity to a client computing entity 102, where the client computing entity 102 may be configured to present an automated testing workflow visualization user interface to an end user based at least in part on the automated testing workflow visualization user interface data entity.

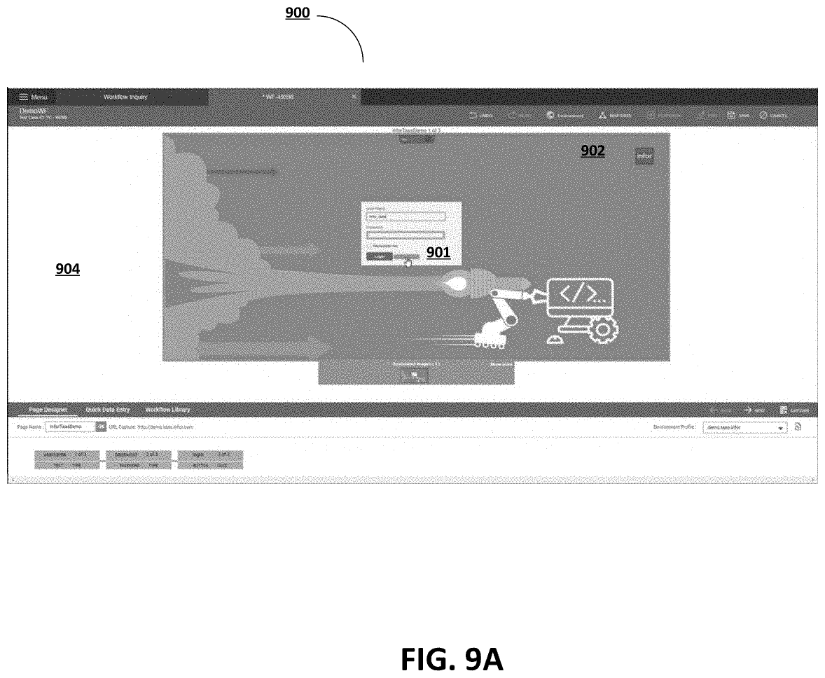

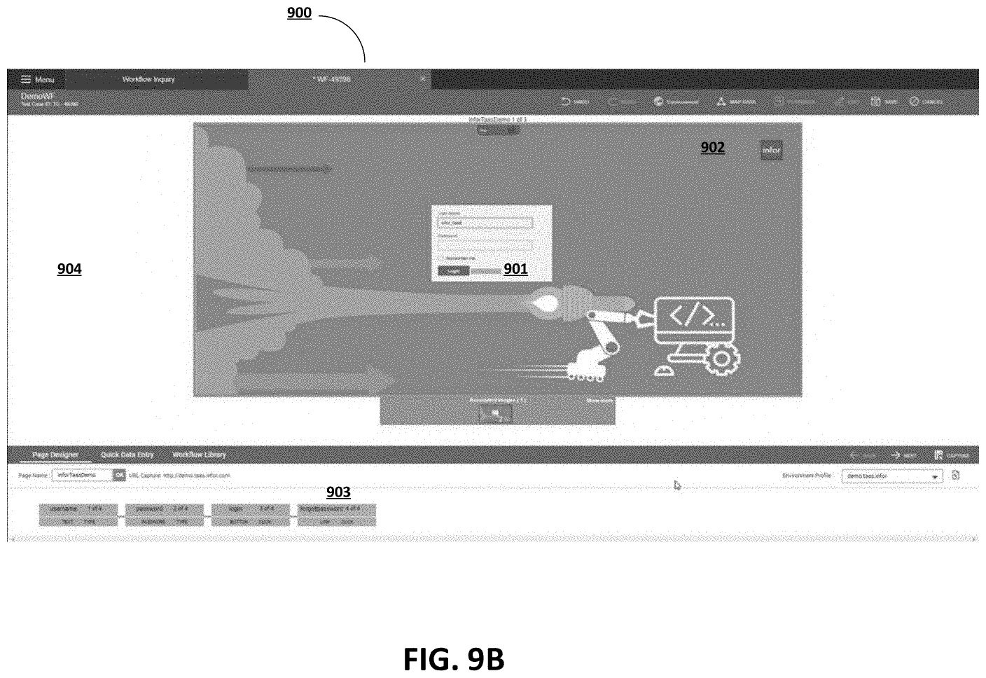

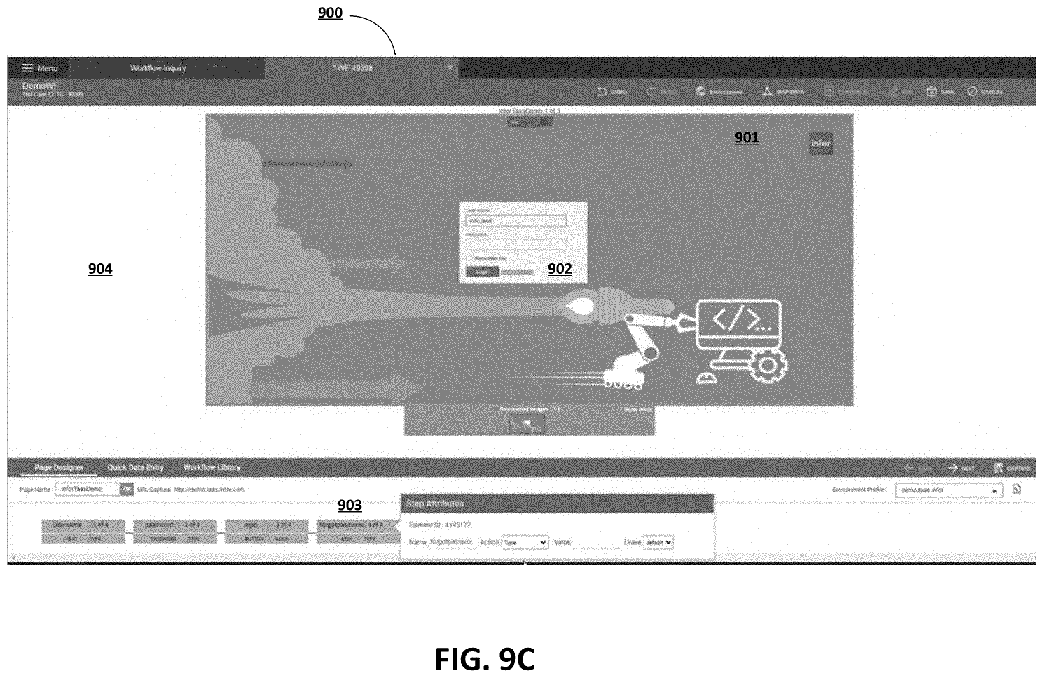

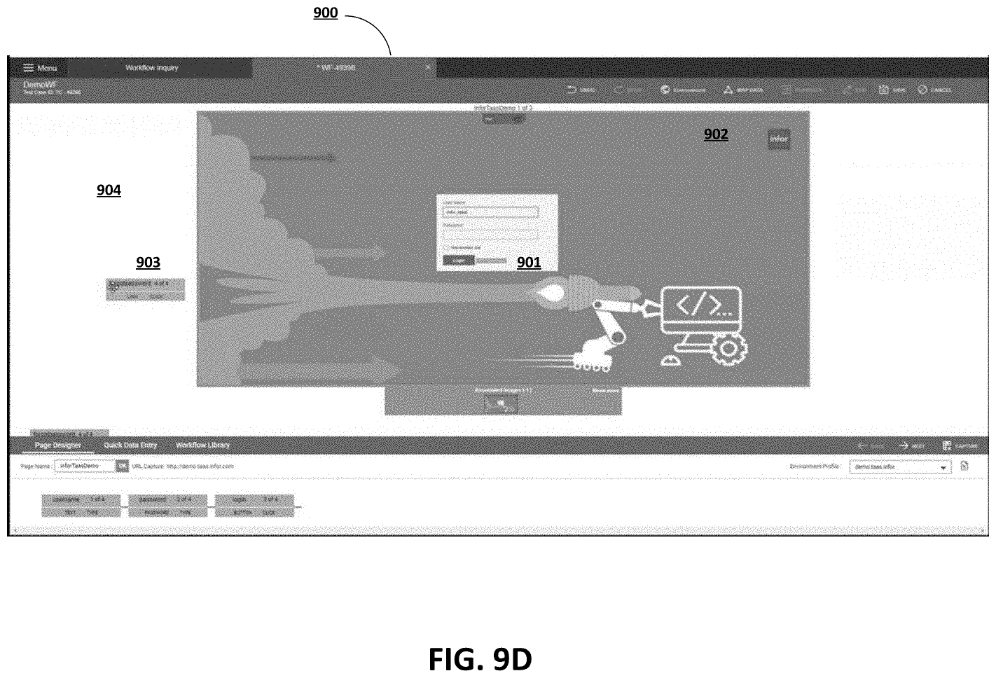

Operational examples of various user actions executed with respect to an automated testing workflow visualization user interface 900 are depicted in FIGS. 9A-9D. For example, as depicted in FIGS. 9A-9B, user interaction with the image region 901 of the currently-displayed captured page image 902 that corresponds to a link element of the corresponding webpage causes the creation of a workflow step action feature element 903 for a new automated testing workflow step that is associated with the link element. As depicted in FIG. 9C, the workflow step action feature element 903 enables the user to define action features for the new automated testing workflow step that is associated with the link element. Moreover, as depicted in FIG. 9D, drag and dropping the workflow step action feature element 903 to a sidebar 904 of the automated testing workflow visualization user interface 900 causes deletion of the workflow step action feature element 903 and the corresponding automated testing workflow step.

In some embodiments, the web server computing entity 104 causes a client computing device to perform a set of web browser operations in response to an end user request to playback the session data entity. In some embodiments, in response to the end user request, the web server computing entity 104 transmits instructions to the screen capture component of the client computing entity 102 to load the webpages associated with the session data entity, locate the interactive page elements associated with the session data entity based at least in part on element location/description metadata provided to the client computing device provided by the web server computing entity 104 to the client computing entity 102, and perform a set of simulated user actions corresponding to the user actions of the captured user interactions associated with the session data entity. In some embodiments, the screen capture component performs the set of simulated user actions by attaching itself to the action methods of the located captured user interactions associated with the session data entity. In some embodiments, once the screen capture component first locates an interactive page element, it records the element location method that was used to detect the element and provides the element location method to the screen capture component in future playback operations to facilitate element location. In some embodiments, to locate interactive page elements, the screen capture component using a configurator that is configured to detect some interactive page elements have defined interactive page element types based on xpath features of those interactive page elements.

In some embodiments, performing testing operations based at least in part on automated testing workflow data entities that are generated using screen capture techniques described above reduces the number of erroneous testing operations. Reducing the number of erroneous testing operations in turn improves the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to enable software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### Nestable Automated Testing Workflow Data Entities

A nestable automated testing workflow data entity may describe an automated testing workflow data entity that may be integrated as unit into other automated testing workflow data entity, where modification of the nestable automated testing workflow data entity causes corresponding modifications for any automated testing workflow data entities that have integrated the nestable automated testing workflow data entity. The automated testing workflow data entities that have integrated a nestable automated testing workflow data entity are referred to as integrative automated testing workflow data entities for the nestable automated testing workflow data entities. In some embodiments, to integrate the modifications to a nestable automated testing workflow data entity into the integrative automated testing workflow data entities that are associated with the nestable automated testing workflow data entity, a computing entity may: (i) detect one or more nestable workflow modifications for the nestable automated testing workflow data entity, wherein the nestable automated testing workflow data entity is associated with a plurality of nestable captured page images and a plurality of nestable automated testing workflow steps; and (ii) for each integrative automated testing workflow data entity: determine a target image subset of a plurality of captured page images of the integrative automated testing workflow data entity that correspond to the plurality of nestable captured page images, determine a target step subset of a plurality of a plurality of automated testing workflow steps of the integrative automated testing workflow data entity that correspond to the plurality of nestable automated testing workflow steps, and update each captured page image in the target image subset and each automated testing workflow step in the target step subset based at least in part on the one or more nestable workflow modifications.

FIG. 10 is a flowchart diagram of an example process 1000 for modifying a nestable automated testing workflow data entity. Via the various steps/operations of the process 1000, the web server computing entity 104 can propagate changes to a nestable automated testing workflow data entity across all integrative a nestable automated testing workflow data entities that have integrated the nestable a nestable automated testing workflow data entity.

The process 1000 begins at step/operation 1001 when the web server computing entity 104 detects one or more nestable workflow modifications for the nestable automated testing workflow data entity. A nestable workflow modification may describe a change to at least one of: (i) the set of nestable captured page images of the nestable automated testing workflow data entity; or (ii) the set of nestable automated testing workflow steps for the nestable automated testing workflow data entity. For example, with respect to a nestable automated testing workflow data entity that describes a set of nestable automated testing workflow steps for a nestable captured page image of a login webpage that includes a nestable automated testing workflow step associated with typing a username, a nestable automated testing workflow step associated with typing a password, and a nestable automated testing workflow step associated with selecting a login button, a nestable workflow modification may describe that the set of nestable automated testing workflow steps the nestable automated testing workflow data entity include selecting a “remember username” button. As another example, with respect to a nestable automated testing workflow data entity that describes a set of nestable automated testing workflow steps logging into a system via a login webpage, a nestable workflow modification may describe a new captured page image that describe a new configuration of the login webpage. As yet another example, with respect to a nestable automated testing workflow data entity that describes a set of nestable automated testing workflow steps logging into a system via a login webpage, a nestable workflow modification may describe a new captured page image that describe a new configuration of the login webpage along with a new set of nestable automated testing workflow steps for the noted new captured page image.

At step/operation 1002, the web server computing entity 104 identifies one or more integrative automated testing workflow data entities for the nested automated testing workflow data entity. As discussed above, the automated testing workflow data entities that have integrated a nestable automated testing workflow data entity are referred to as integrative automated testing workflow data entities for the nestable automated testing workflow data entities.

In some embodiments, when the web server computing entity 104 integrates a nested automated testing workflow data entity into another automated testing workflow data entity, the web server computing entity 104 determines that the other automated testing workflow data entity is an integrative automated testing workflow data entity for the nested automated testing workflow data entity. Thus, in some embodiments, the web server computing entity 104 may identify the integrative automated testing workflow data entity for the nested by integrating the nested automated testing workflow data entity into the integrative automated testing workflow data entity.

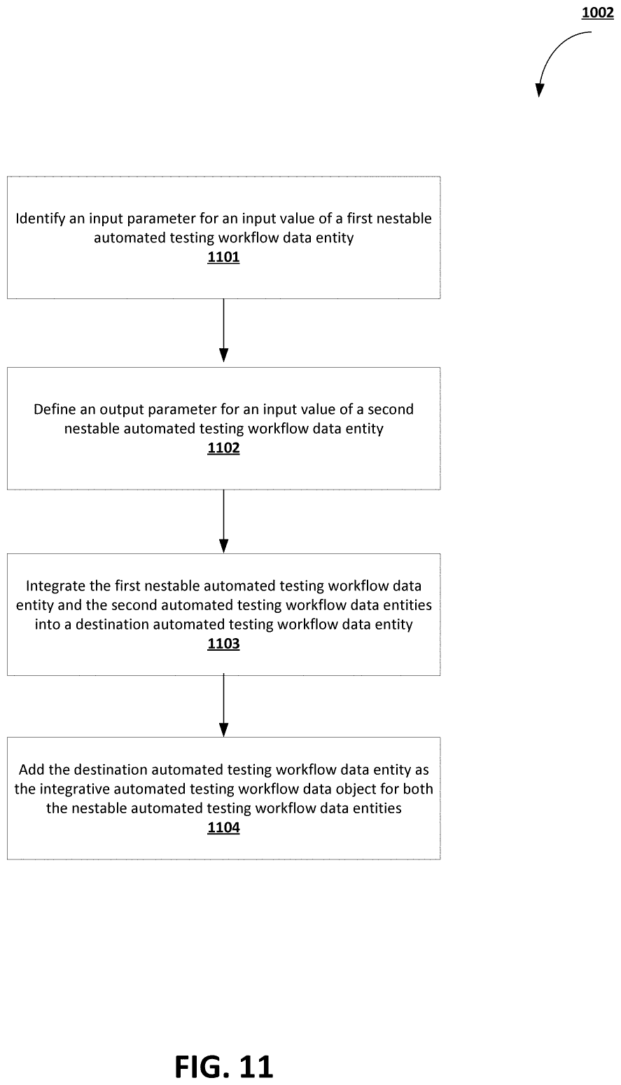

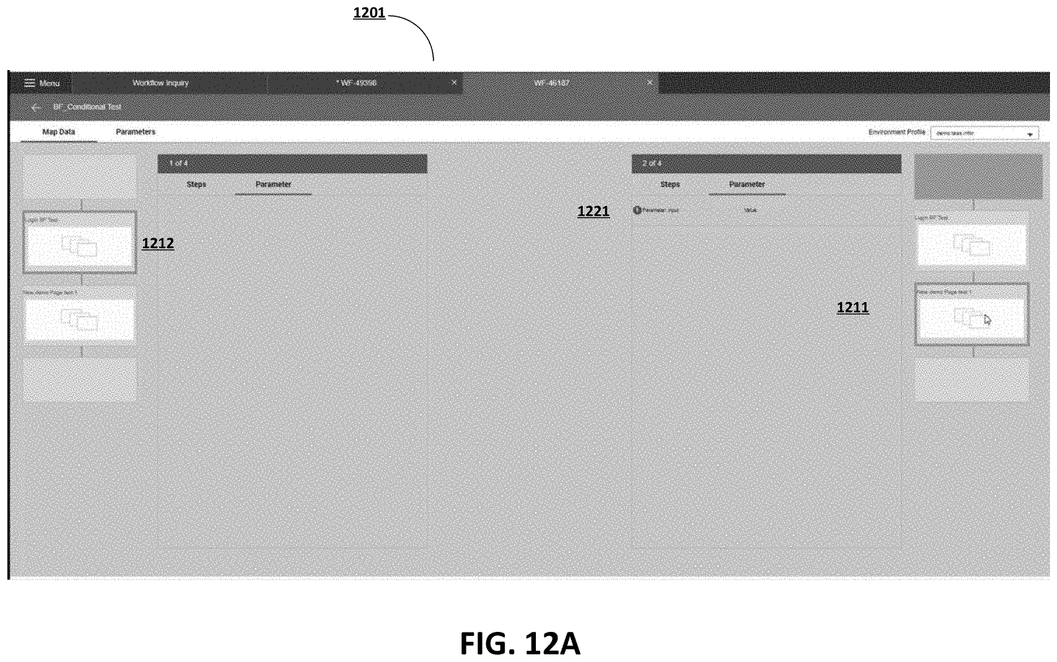

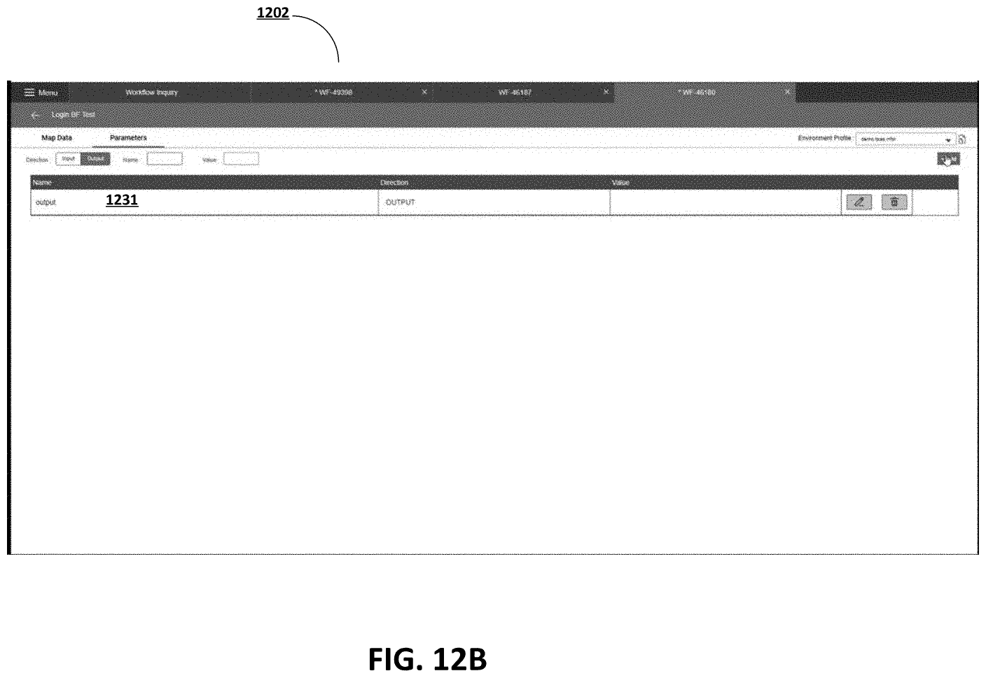

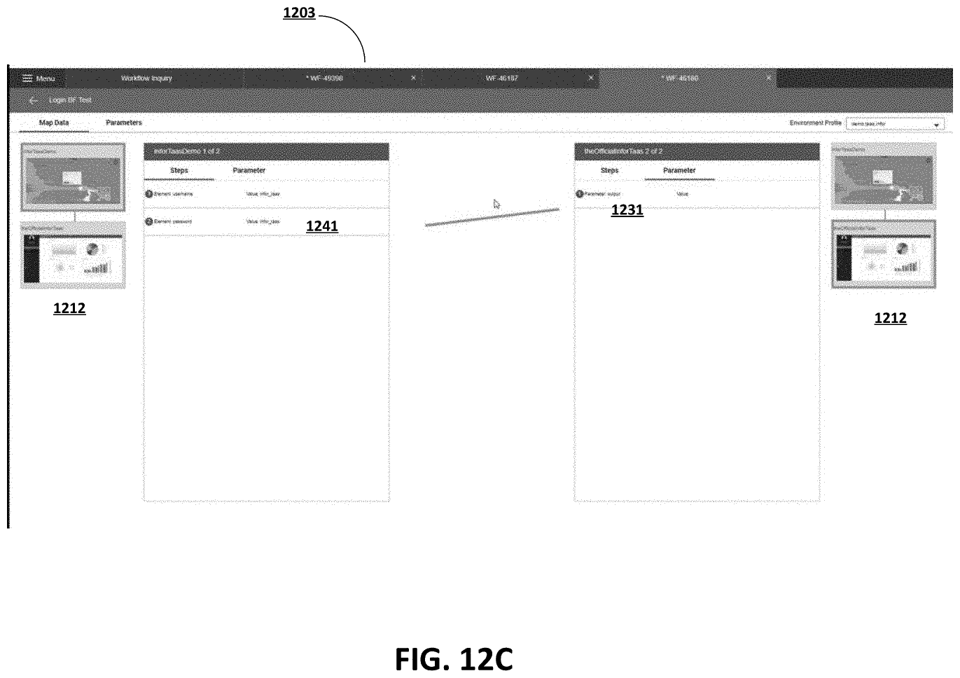

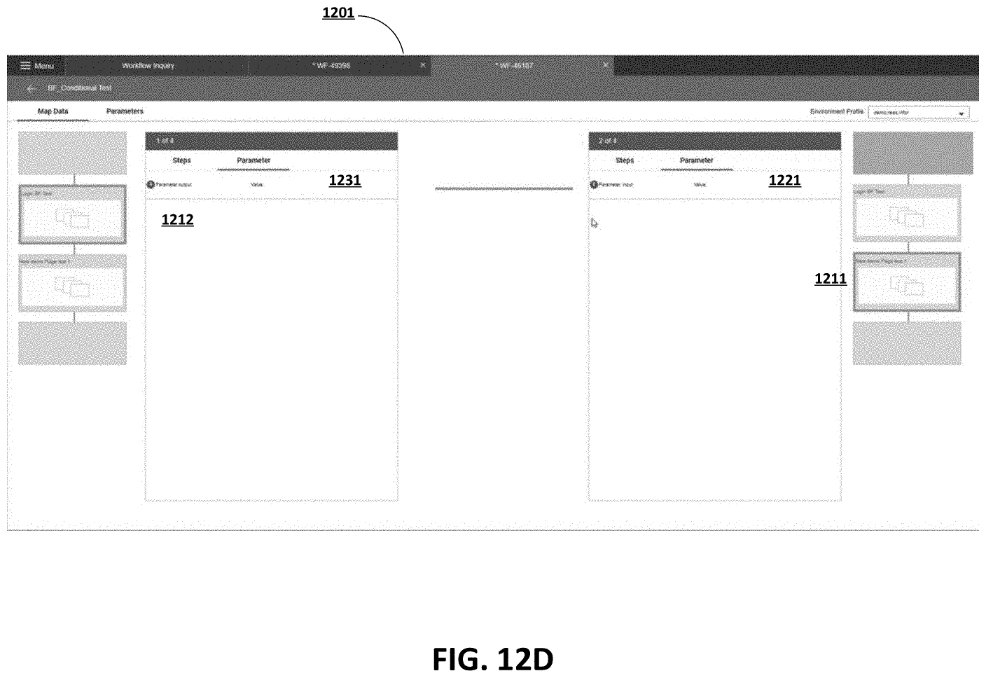

In some embodiments, step/operation 1002 may be executed in accordance with the process that is depicted in FIG. 11, which is an example process of identifying a destination automated testing workflow data entity within which two nestable automated testing workflow data entities have been integrated as an integrative automated testing workflow data entity for the two nestable automated testing workflow data entities. The process that is depicted in FIG. 11 begins at step/operation 1101 when the web server computing entity 104 identifies (e.g., defines or retrieves) an input parameter for an input value of a first nestable automated testing workflow data entity. For example, as depicted in FIG. 12A, the workflow integration user interface 1201 that is associated with a destination automated testing workflow data entity enables identifying the input parameter 1221 for a first nestable automated testing workflow data entity 1211.

An output parameter may describe a value that is determined based at least in part on a user input value for an automated testing workflow data entity test step that corresponds to an interactive page element of a corresponding nestable automated testing workflow data entity, where the value is configured to be used to determine a value of an input parameter of another nestable automated testing workflow data entity. For example, in some embodiments, when two or more automated testing workflow data entities are integrated into a common destination automated testing workflow data entity, then an output parameter of a first nestable of the two or more automated testing workflow data entities may be passed to one or more input parameters of one or more second automated testing workflow data entities of the two or more automated testing workflow data entities.

At step/operation 1102, the web server computing entity 104 identifies (e.g., defines or retrieves) an output parameter for an input value of a second nestable automated testing workflow data entity. For example, as depicted in FIG. 12B, the parameter definition user interface 1202 that is associated with the second nestable automated testing workflow data entity 1212 enables generating the output parameter 1231, which is then (via the parameter mapping user interface 1203 of FIG. 12C that is also associated with the second nestable automated testing workflow data entity 1212) is mapped to an output value 1241 of the second nestable automated testing workflow data entity 1212.

An input parameter may describe a value that is used to determine a user input value for an automated testing workflow data entity test step that corresponds to an interactive page element of a corresponding nestable automated testing workflow data entity, where the value is determined based at least in part on an output parameter of another nestable automated testing workflow data entity. For example, in some embodiments, when two or more automated testing workflow data entities are integrated into a common destination automated testing workflow data entity, then an output parameter of a first nestable of the two or more automated testing workflow data entities may be passed to one or more input parameters of one or more second automated testing workflow data entities of the two or more automated testing workflow data entities.

At step/operation 1103, the web server computing entity 104 integrates the first nestable automated testing workflow data entity and the second automated testing workflow data entity into the destination automated testing workflow data entity by mapping the output parameter of the second nestable automated testing workflow data entity to the input parameter of the third nestable automated testing workflow data entity. For example, as depicted in FIG. 12D, the workflow integration user interface 1201 that is associated with a destination automated testing workflow data entity enables mapping the output parameter 1231 of the second nestable automated testing workflow data entity 1212 to the input parameter 1221 of the first nestable automated testing workflow data entity 1211.

In some embodiments, as part of integrating the first nestable automated testing workflow data entity and the second nestable automated testing workflow data entity, the web server computing entity 104 adds the nestable captured page images and the nestable automated testing workflow test steps associated with the two automated testing workflow data entities into appropriate positions within the destination automated testing workflow data entities. For example, as depicted in FIGS. 12A and 12D, the first nestable automated testing workflow data entity 1211 is integrated in the third position of the destination automated testing workflow data entity, while the second nestable automated testing workflow data entity 1212 is integrated in the second position of the automated testing workflow data entity.

At step/operation 1104, the web server computing entity 104 adds the destination automated testing workflow data entity as an integrative automated testing workflow data entity for both the nestable automated testing workflow data entities. In some embodiments, because the destination automated testing workflow data entity integrates both the first nestable and the second nestable automated testing workflow data entity, the destination automated testing workflow data entity is deemed both as an integrative automated testing workflow data entity for the first nestable automated testing workflow data entity and as an integrative automated testing workflow data entity for the second nestable automated testing workflow data entity.

Returning to FIG. 10, at step/operation 1003, the web server computing entity 104 updates the integrative automated testing workflow data entities identified at step/operation 1002 based at least in part on the nestable workflow modifications identified at step/operation 1001. In some embodiments, updating an integrative automated testing workflow data entity for the nestable automated testing workflow data entity comprises: determining a target image subset of a plurality of captured page images of the integrative automated testing workflow data entity that correspond to the plurality of nestable captured page images of the nestable automated testing workflow data entity, determining a target step subset of a plurality of automated testing workflow steps of the integrative automated testing workflow data entity that correspond to the plurality of nestable automated testing workflow steps of the nestable automated testing workflow data entity, and updating each captured page image in the target image subset and each automated testing workflow step in the target step subset based at least in part on the one or more nestable workflow modifications.

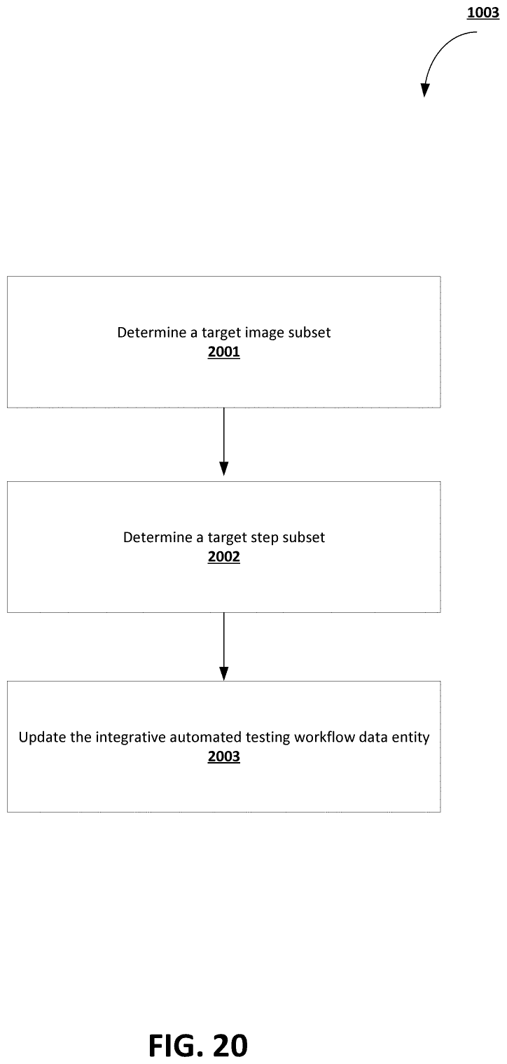

In some embodiments, step/operation 1003 may be executed in accordance with the process that is depicted in FIG. 20, which is an example process of updating an integrative automated testing workflow data entity for a nestable automated testing workflow data entity based at least in part on the nestable workflow modifications for the nestable automated testing workflow data entity. The process that is depicted in FIG. 20 begins at step/operation 2001 when the web server computing entity determines a target image subset of a plurality of captured page images of the integrative automated testing workflow data entity that correspond to the plurality of nestable captured page images of the nestable automated testing workflow data entity. For example, in the operational example that is depicted in FIGS. 12A and 12D, given the first nestable automated testing workflow data entity 1211, the target image subset includes the captured page images of the destination automated testing workflow data entity that are associated with the third webpage for the automated testing workflow data entity.

At step/operation 2002, the web server computing entity 104 determines a target step subset of a plurality of automated testing workflow steps of the integrative automated testing workflow data entity that correspond to the plurality of nestable automated testing workflow steps of the nestable automated testing workflow data entity. For example, in the operational example that is depicted in FIGS. 12A and 12D, given the first nestable automated testing workflow data entity 1211, the target step subset includes each automated testing workflow data entity that is associated with the target image subset.

At step/operation 2003, the web server computing entity 104 updates the integrative automated testing workflow data entity based at least in part on the target image subset and the target step subset. In some embodiments, the web server computing entity 104 updates the nestable captured page images of the nestable automated testing workflow data entity to correspond to the captured page images in the target image subset. In some embodiments, the web server computing entity 104 updates the nestable automated testing workflow steps associated with the nestable automated testing workflow data entity to correspond to the automated testing workflow steps in the target step subset. In some embodiments, the web server computing entity 104 updates the integrative automated testing workflow data entity to reflect the relationships between the captured page images in the target image subset and the automated testing workflow steps in the target step subset in the relationships between nestable captured page images and nestable automated testing workflow steps that correspond to the nestable automated testing workflow data entity.

Returning to FIG. 10, at step/operation 1004, the web server computing entity 104 provides access to the integrative automated testing workflow data entities using a set of integrative automated testing workflow visualization user interfaces. In some embodiments, the web server computing entity 104 generates an integrative automated testing workflow visualization user interface data entity for each integrative automated testing workflow visualization user interface and provides the integrative automated testing workflow visualization user interface data entities to a client computing entities 102, where the client computing entities 102 may be configured to present integrative automated testing workflow visualization user interfaces to their respective end users based at least in part on the integrative automated testing workflow visualization user interface data entities.

In some embodiments, performing testing operations based at least in part on automated testing workflow data entities that are generated using nestable automated testing workflow data entities reduces the number of erroneous testing operations. Reducing the number of erroneous testing operations in turn improves the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to enable software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### Reliability Monitoring for Automated Testing Workflow Data Entities

Once generated, an automated testing workflow data entity may lose its operational reliability if the configuration and/or layout of at least one webpage associated with the automated testing workflow data entity changes in a manner that prevents the ability to map at least one automated testing workflow step associated with the automated testing workflow data entity to an interactive page element of the at least one webpage. For example, consider a scenario in which an automated testing workflow data entity comprises an automated testing workflow step that is associated with a link element that is subsequently removed from a corresponding webpage. In some embodiments, the web server computing entity 104 is configured to detect that the automated testing workflow step is no longer associated with a detectable interactive page element and generate data that is configured to notify a user of this operational failure in order to enable the user to address the operational failure.

FIG. 13 is a flowchart diagram of an example process 1300 for generating an execution log for an automated testing workflow data entity. Via the various steps/operations of the process 1300, the web server computing entity 104 is configured to execute a set of workflow playback operations to detect any operational failures associated with the automated testing workflow steps of the automated testing workflow entity.

The process 1300 begins at step/operation 1301 when the web server computing entity 104 identifies an ordered sequence of automated testing workflow steps for the automated testing workflow data entity. In some embodiments, the ordered sequence of automated testing workflow steps for the automated testing workflow data entity include all of the automated testing workflow steps of the automated testing workflow data entity as ordered based both on the ordering of automated testing workflow steps within captured page images and ordering of webpages associated with captured page images.

For example, consider an automated testing workflow data entity that is associated with the following sequence of webpages W1→W2→W3, where W1 is associated with the following sequence of automated testing workflow steps S→S2→S3, W2 is associated with the following sequence of automated testing workflow steps S4→S5, and W3 is associated with the following sequence of automated testing workflow steps S6→S7→S8→S9. In this example, the ordered sequence of automated testing workflow steps for the exemplary automated testing workflow data entity may include: S1→S2→S3→S4→S5→S6→S7→S8→S9.

As described above, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

In some embodiments, the automated testing workflow data entity may define, for each captured page image associated with an automated testing workflow data entity, a set of automated testing workflow steps. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; and (iii) a user action sequence identifier of the user action that may describe a temporal order of the user action within a set of sequential user actions executed with respect to interactive page elements of a webpage associated with the user action.

At step/operation 1302, the web server computing entity 104 executes a required number of workflow playback operations based at least in part on the ordered sequence until a terminal workflow playback operation that is associated with a target automated testing workflow step that is a first automated testing workflow step with a negative success indicator. In some embodiments, the web server computing entity 104 performs a workflow playback operation for each automated testing workflow step until a first automated testing workflow step that is associated with an interactive page element that cannot be located within a corresponding webpage and/or with respect to which a captured user interaction associated with the automated testing workflow step cannot successfully be performed.

In general, a workflow playback operation may describe an operation that is configured to perform a captured user action associated with a corresponding automated testing workflow step within a web environment of the automated testing workflow data entity that comprises the corresponding automated testing workflow step. In some embodiments, executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step.

As used herein, the success indicator may be a value that is configured to describe whether a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step. In some embodiments, if a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a positive value. In some embodiments, if a corresponding workflow playback operation associated with a corresponding automated testing workflow step has not successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a negative value. In some embodiments, the success indicator for a workflow playback operation that is associated with an automated testing workflow step may be negative if one of the following conditions is satisfied: (i) no interactive page element is detected at a page region of a corresponding webpage that is determined in accordance with the element location data for the automated testing workflow step, or (ii) an interactive page element is detected at a page region of a corresponding webpage that is determined in accordance with the element location data for the automated testing workflow step, but the detected interactive page element has an element type that is inconsistent with an element type of an interactive page element for the corresponding automated testing workflow step as determined in accordance with the element type data for the automated testing workflows step.

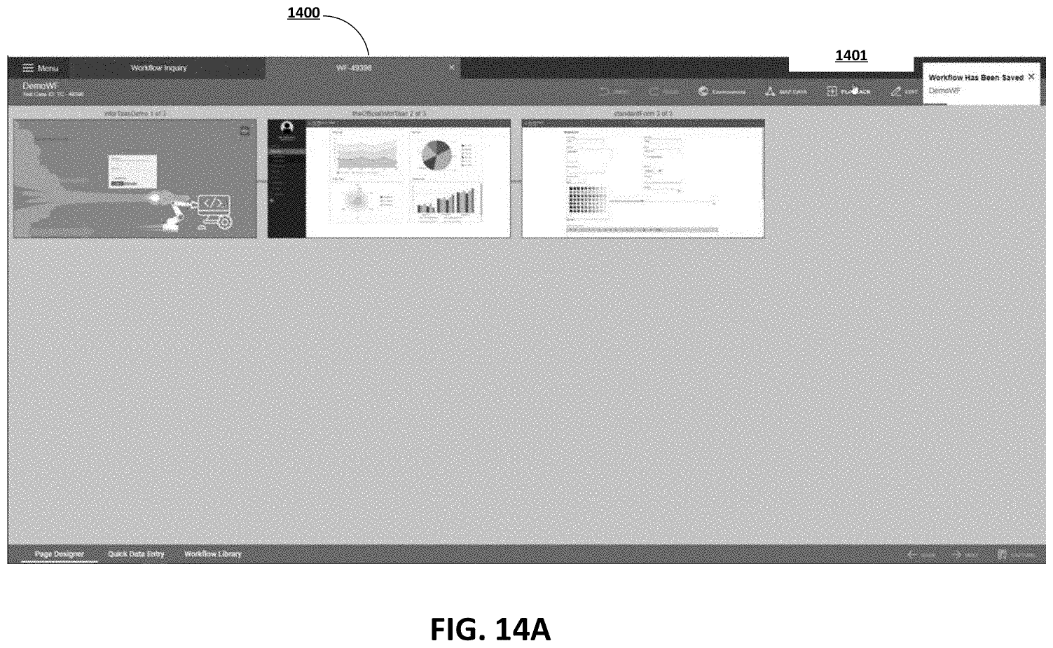

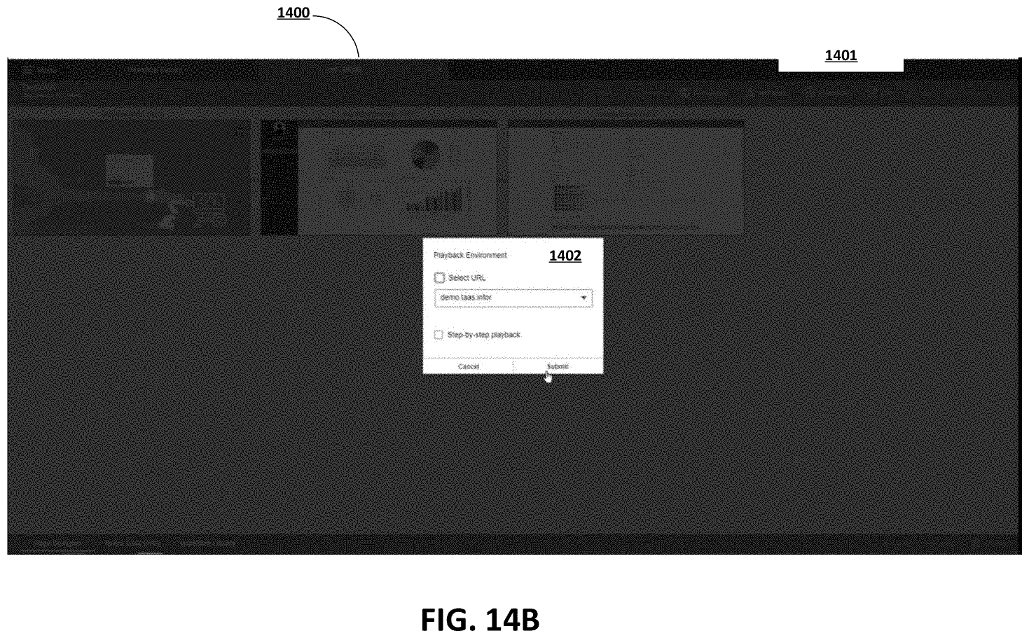

In some embodiments, to execute the required number of workflow playback operations, a user first selects the button 1401 within the automated testing workflow visualization user interface 1400 of FIGS. 14-A-B, where user selection of the button 1401 causes the presentation of the element 1402 which enables the user to provide the starting playback environment for the required number of workflow playback operations, along with configurations about whether the user desires to control step-by-step transitions of the workflow playback operations corresponding to the automated testing workflow steps.

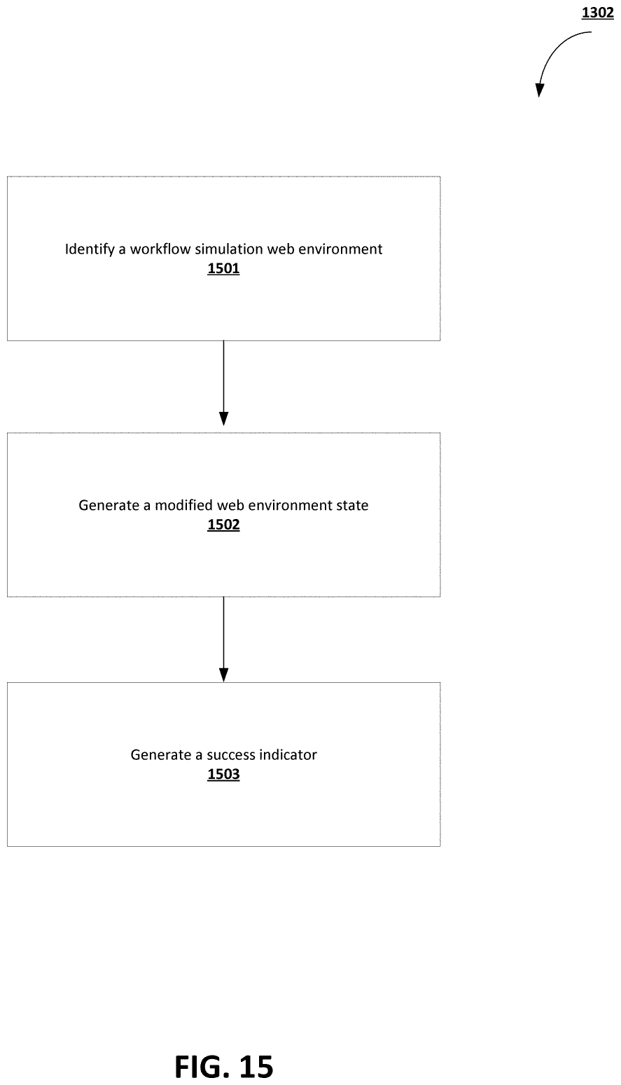

In some embodiments, performing a workflow playback operation for an automated testing workflow step is performed in accordance with the process that is depicted in FIG. 15. The process that is depicted in FIG. 15 begins at step/operation 1501 when the web server computing entity 104 identifies a workflow simulation environment for the workflow playback operation. The workflow simulation environment may be a web session within which the webpage associated with the automated testing workflow step is loaded.

At step/operation 1502, the web server computing entity 104 generates a modified web environment state for the workflow simulation environment by modifying the workflow simulation environment in accordance with the automated testing workflow step. In some embodiments, to generate the modified web environment state, the web server computing entity 104 modifies a web environment state of the workflow simulation web environment based at least in part on a captured user interaction for the automated testing workflow step.

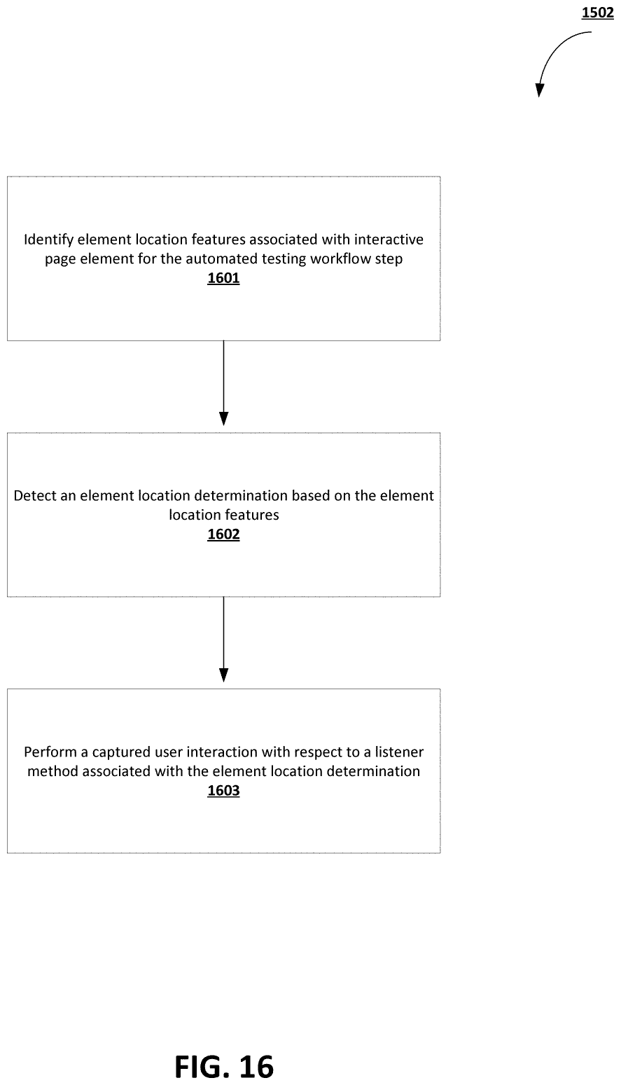

In some embodiments, step/operation 1502 may be performed in accordance with the process that is depicted in FIG. 16. The process that is depicted in FIG. 16 begins at step/operation 1601 when the web server computing entity 104 identifies location features associated with the interactive page element for the automated testing workflow step. A location feature for an interactive page element may be any data field that describe a relative and/or absolute location of the interactive page element within a layout of a corresponding webpage. Examples of location features include location coordinates and/or location coordinate checksums.

At step/operation 1602, the web server computing entity 104 detects an element location determination based at least in part on the element location features. The element location determination may be any data entity that maps the interactive page element for the automated testing workflow step to a detected interactive page element within a corresponding webpage, where the mapping may be performed based at least in part on the element location features associated with the interactive page element for the automated testing workflow step.

At step/operation 1603, the web server computing entity 104 performs the captured user interaction associated with the automated testing workflow step with respect to a listener method associated with the element location determination. In some embodiments, the web server computing entity 104 performs the captured user interaction associated with the automated testing workflow step by activating the listener method associated with the element location determination. In some embodiments, to perform the captured user interaction, the web server computing entity 104 first identifies the listener method within the HTML Document Object Model (DOM) of the corresponding webpage, and then performs the captured user interaction associated with the automated testing workflow step by activating (e.g., calling) the identified listener method.

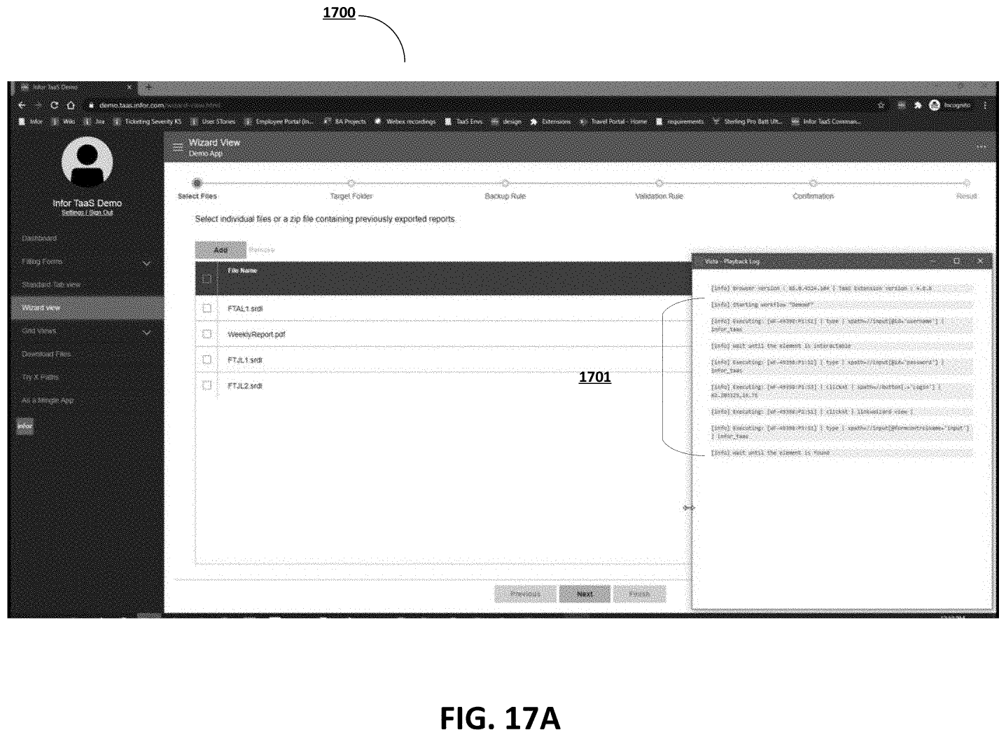

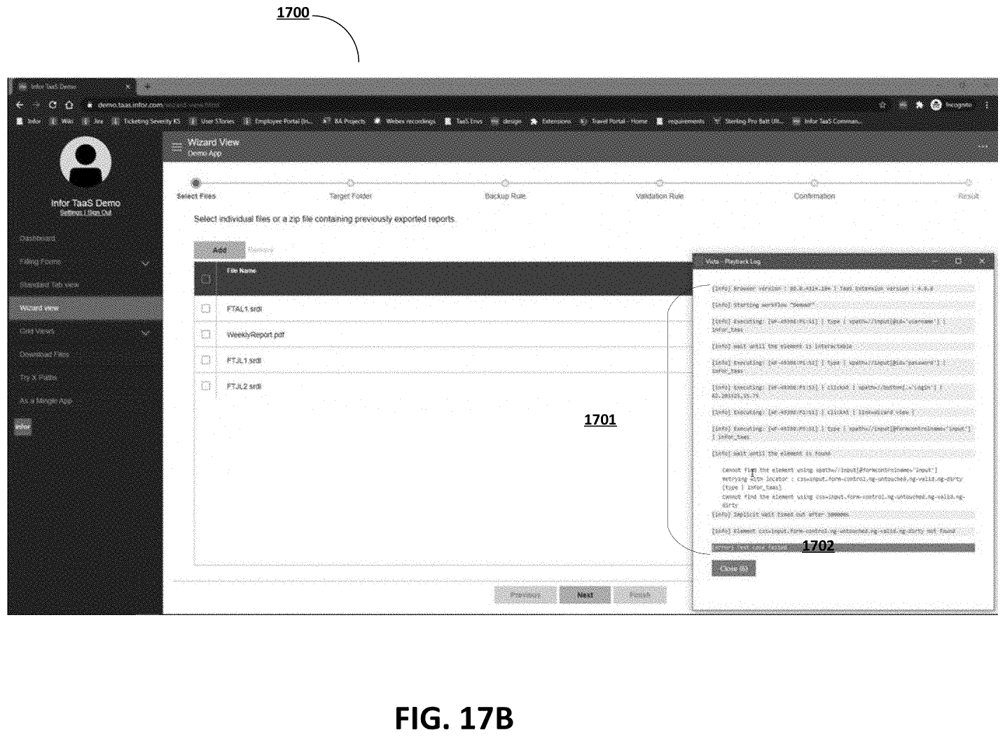

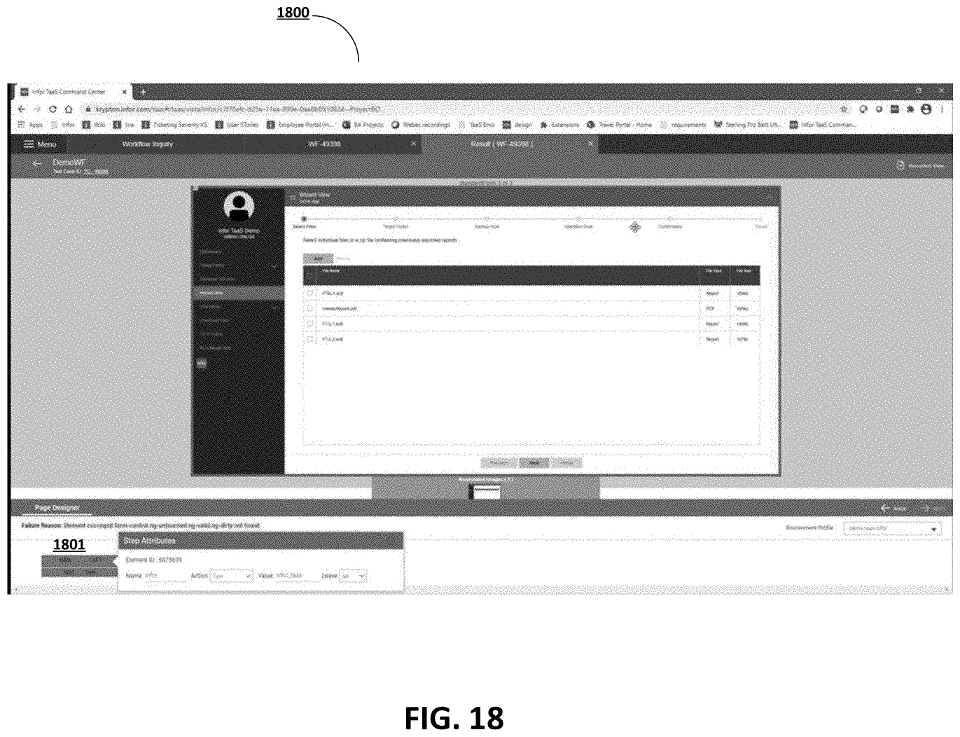

Returning to FIG. 13, the required number of workflow playback operations are executed based at least in part on the ordered sequence until a terminal workflow playback operation that is associated with a target automated testing workflow step that is either: (i) a first automated testing workflow step with a negative success indicator, or (ii) if none of the automated testing workflow steps are associated with a negative success indicator (i.e., if all of the automated testing workflow steps are associated with a positive successor indicator), the last workflow playback operation in the ordered sequence. For example, in the workflow playback user interface 1700 of FIG. 17A, the execution log 1701 depicts that all the executed workflow playback operations have a positive success indicator. However, in the workflow playback user interface 1700 of FIG. 17B, the execution log 1701 depicts that a terminal executed workflow playback operation has a negative success indicator. User selection of the log field 1702 associated with the terminal executed workflow playback operation in FIG. 17 causes displaying the workflow step action feature element 1801 for the automated testing workflow step associated with the terminal executed workflow playback operation in the automated testing workflow visualization user interface 1800 of FIG. 18.

At step/operation 1303, the web server computing entity 104 generates the execution log based at least in part on the modified web environment state for the target automated testing workflow step that is associated with the terminal workflow playback operation. The execution log may describe at least one success indicator associated with a workflow playback operation of the required number of workflow playback operations. In some embodiments, the execution log describes an affirmative execution log field for each automated testing workflow step that is associated with the required number of workflow playback operations other than the terminal workflow playback operation. In some embodiments, the execution log describes a negative execution log field for the target automated testing workflow step that is associated with terminal workflow playback operation. In some embodiments, user selection of the negative execution log causes generating user interface data for a workflow step action feature element that is associated with the target automated testing workflow step. In some embodiments, modifying the target automated testing workflow step can be performed via user interaction with the workflow step action feature element.

In some embodiments, the execution log for an automated testing workflow step describes whether the automated testing workflow step is skipped. In some of the noted embodiments, to determine whether to skip a set of automated testing workflow steps, the following operations are performed: a state handling logic checks to see whether the application is in a proper state (e.g., where state determines whether an on-screen prompt, navigation panel, and/or other visible set of elements may or may not be displayed). If the state of the application does not meet the criteria for automated testing workflow steps to be executed to put the application into the proper state, the associated automated testing workflow steps will be skipped, while when the state of the application meets the criteria for automated testing workflow steps to execute to put the application into the proper state, the automated testing workflow steps will execute instead of being skipped.

In some embodiments, a negative success indicator may be associated with at least one of an interactive page element such as a label, a button, a field, and/or the like. In some embodiments, a negative success indicator may be represented by at least one of: (i) highlighting of the region for a corresponding interactive page element for the negative success indicator in a captured page image, (ii) highlighting of the corresponding automated testing workflow step for the negative success indicator in an automated testing workflow visualization user interface, (iii) a log message indicating the failure reason for the negative success indicator, and (iv) a list of all successful automated testing workflow steps preceding the automated testing workflow step that is associated with the negative success indicator.

At step/operation 1304, the web server computing entity 104 provides access to the execution log using a workflow playback visualization user interface. In some embodiments, the workflow playback visualization user interface is configured to: (i) display the execution log; and (ii) enable modifying the target automated testing workflow step. In some embodiments, the web server computing entity 104 is configured to generate a workflow playback visualization user interface data entity for the workflow playback visualization user interface to a client computing entity 102, where the client computing entity 102 may be configured to generate the workflow playback visualization user interface based at least in part on the workflow playback visualization user interface data entity and present the workflow playback user interface to an end user of the client computing entity 102.

In some embodiments, performing testing operations based at least in part on automated testing workflow data entities that are generated/refined using the reliability monitoring described above reduces the number of erroneous testing operations. Reducing the number of erroneous testing operations in turn improves the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to enable software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

In some embodiments, during executing a set of workflow playback operations, some web browser APIs present same origin issues. For example, in Chrome, an API request going via the chrome extensions has chrome://extensions/xxxxxxxxxxxxx as the origin header, and some servers rejected these calls due to the same-origin policy. There is no option in JavaScript to pragmatically change the origin due to security concerns. To address this same origin issue, the screen capture component (e.g., a web browser extension) listens to each API call going through the browser, and if any call is identified as a playing back of an API call, the origin of the API call will be set as the requesting domain to avoid the same origin issue.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating an execution log for an automated testing workflow data entity, the computer-implemented method comprising:
identifying, using one or more processors, an ordered sequence of automated testing workflow steps for the automated testing workflow data entity;
causing a computing entity to execute, using the one or more processors, a required number of workflow playback operations based at least in part on the ordered sequence, wherein:
each workflow playback operation is associated with an automated testing workflow step in the ordered sequence,
the required number of workflow playback operations stop with a terminal workflow playback operation that is associated with a target automated testing workflow step,
the target automated testing workflow step is a first automated testing workflow step with a negative success indicator, and
executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step;
generating, using the one or more processors, the execution log based at least in part on the modified web environment state for the target automated testing workflow step; and
providing, using the one or more processors, access to the execution log using a workflow visualization playback user interface, wherein the workflow playback visualization user interface is configured to: (i) display the execution log; and (ii) enable modifying the target automated testing workflow step.

2. The computer-implemented method of claim 1, wherein the execution log describes an affirmative execution log field for each automated testing workflow step that is associated with the required number of workflow playback operations other than the terminal workflow playback operation.

3. The computer-implemented method of claim 1, wherein the execution log describes a negative execution log field for the target automated testing workflow step that is associated with terminal workflow playback operation.

4. The computer-implemented method of claim 3, wherein user selection of the negative execution log causes generating user interface data for a workflow step action feature element that is associated with the target automated testing workflow step.

5. The computer-implemented method of claim 4, wherein modifying the target automated testing workflow step can be performed via user interaction with the workflow step action feature element.

6. The computer-implemented method of claim 1, wherein generating the modified web environment state during a particular workflow playback operation comprises:
identifying one or more element location features associated with the interactive page element for the automated testing workflow step that is associated with the particular workflow playback operation;
detecting an element location determination based at least in part on the one or more element location features; and
performing a captured user interaction with respect to a listener method associated with the element location determination.

7. The computer-implemented method of claim 6, wherein performing the captured user interaction with respect to the listener method comprises activating the listener method.

8. An apparatus for modifying a nestable automated testing workflow data entity, the apparatus comprising at least one processor and at least one memory including program code, the at least one memory and the program code configured to, with the processor, cause the apparatus to at least:
identify an ordered sequence of automated testing workflow steps for the automated testing workflow data entity;
cause a computing entity to execute a required number of workflow playback operations based at least in part on the ordered sequence, wherein:
each workflow playback operation is associated with an automated testing workflow step in the ordered sequence,
the required number of workflow playback operations stop with a terminal workflow playback operation that is associated with a target automated testing workflow step that is a first automated testing workflow step with a negative success indicator, and executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step;
generate the execution log based at least in part on the modified web environment state for the target automated testing workflow step; and
provide access to the execution log using a workflow visualization playback user interface, wherein the workflow playback visualization user interface is configured to: (i) display the execution log; and (ii) enable modifying the target automated testing workflow step.

9. The apparatus of claim 8, wherein the execution log describes an affirmative execution log field for each automated testing workflow step that is associated with the required number of workflow playback operations other than the terminal workflow playback operation.

10. The apparatus of claim 8, wherein the execution log describes a negative execution log field for the target automated testing workflow step that is associated with terminal workflow playback operation.

11. The apparatus of claim 10, wherein user selection of the negative execution log causes generating user interface data for a workflow step action feature element that is associated with the target automated testing workflow step.

12. The apparatus of claim 11, wherein modifying the target automated testing workflow step can be performed via user interaction with the workflow step action feature element.

13. The apparatus of claim 9, wherein generating the modified web environment state during a particular workflow playback operation comprises:
identifying one or more element location features associated with the interactive page element for the automated testing workflow step that is associated with the particular workflow playback operation;
detecting an element location determination based at least in part on the one or more element location features; and
performing a captured user interaction with respect to a listener method associated with the element location determination.

14. The apparatus of claim 13, wherein performing the captured user interaction with respect to the listener method comprises activating the listener method.

15. A computer program product for generating an execution log for an automated testing workflow data entity, the computer program product comprising at least one non-transitory computer-readable storage medium having computer-readable program code portions stored therein, the computer-readable program code portions configured to:
identify an ordered sequence of automated testing workflow steps for the automated testing workflow data entity;
cause a computing entity to execute a required number of workflow playback operations based at least in part on the ordered sequence, wherein:
each workflow playback operation is associated with an automated testing workflow step in the ordered sequence,
the required number of workflow playback operations stop with a terminal workflow playback operation that is associated with a target automated testing workflow step that is a first automated testing workflow step with a negative success indicator, and
executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step;
generate the execution log based at least in part on the modified web environment state for the target automated testing workflow step; and
provide access to the execution log using a workflow visualization playback user interface, wherein the workflow playback visualization user interface is configured to: (i) display the execution log; and (ii) enable modifying the target automated testing workflow step.

16. The computer program product of claim 15, wherein the execution log describes an affirmative execution log field for each automated testing workflow step that is associated with the required number of workflow playback operations other than the terminal workflow playback operation.

17. The computer program product of claim 15, wherein the execution log describes a negative execution log field for the target automated testing workflow step that is associated with terminal workflow playback operation.

18. The computer program product of claim 17, wherein user selection of the negative execution log causes generating user interface data for a workflow step action feature element that is associated with the target automated testing workflow step.

19. The computer program product of claim 18, wherein modifying the target automated testing workflow step can be performed via user interaction with the workflow step action feature element.

20. The computer program product of claim 15, wherein generating the modified web environment state during a particular workflow playback operation comprises:
identifying one or more element location features associated with the interactive page element for the automated testing workflow step that is associated with the particular workflow playback operation;
detecting an element location determination based at least in part on the one or more element location features; and
performing a captured user interaction with respect to a listener method associated with the element location determination.
